(19) United States
(12) Patent Application Publication
(10) Pub. No.: US 2014/0081820 A1
(43) Pub. Date: Mar. 20, 2014

(54) METHODS AND SYSTEMS FOR INTER-ACCOUNT MARGIN OPTIMIZATION

(71) Applicants: Corey Farabi, Chicago, IL (US); Chad Voegele, Chicago, IL (US); Matt Simpson, Wheaton, IL (US); Keith A. Anguish, Homer Glen, IL (US); Steve Ishmael, Chicago, IL (US); Dmitriy Glinberg, Northbrook, IL (US); Igor Zolotarev, Naperville, IL (US); Rafet Evren Baysal, Chicago, IL (US); Jingbin Yin, Naperville, IL (US); Ziyi Wang, Chicago, IL (US)

(72) Inventors: Corey Farabi, Chicago, IL (US); Chad Voegele, Chicago, IL (US); Matt Simpson, Wheaton, IL (US); Keith A. Anguish, Homer Glen, IL (US); Steve Ishmael, Chicago, IL (US); Dmitriy Glinberg, Northbrook, IL (US); Igor Zolotarev, Naperville, IL (US); Rafet Evren Baysal, Chicago, IL (US); Jingbin Yin, Naperville, IL (US); Ziyi Wang, Chicago, IL (US)

(21) Appl. No.: 13/891,701

(22) Filed: May 10, 2013

Related U.S. Application Data
(60) Provisional application No. 61/701,350, filed on Sep. 14, 2012.

(51) Int. Cl. G06Q 40/04

(52) U.S. Cl. CPC G06Q 40/04
USPC 705/37

(57) ABSTRACT

The disclosed embodiments relate to reducing, minimizing or otherwise optimizing margin requirements for a trader having both an interest rate (IR) futures and over-the-counter (OTC) interest rate swaps (IRS) accounts by efficiently allocating IR futures across both accounts.

### RELATED APPLICATIONS

This application claims the benefit of U.S. Provisional Application No. 61/701,350, filed Sep. 14, 2012. The entire contents of the provisional application are incorporated herein by reference, except that in the event of any inconsistent disclosure or definition from the present specification, the disclosure or definition herein shall be deemed to prevail.

### BACKGROUND

A financial instrument trading system, such as a futures exchange (referred to herein also as an “Exchange”), an example of which is the Chicago Mercantile Exchange Inc. (CME), provides a contract market where financial instruments, such as futures and options on futures, are traded. The term “futures” is used to designate all contracts for the purchase or sale of financial instruments or physical commodities for future delivery or cash settlement on a commodity futures exchange. A futures contract is a legally binding agreement to buy or sell a commodity at a specified price at a predetermined future time. An option is the right, but not the obligation, to sell or buy the underlying instrument (in this case, a futures contract) at a specified price within a specified time. The commodity to be delivered in fulfillment of the contract or, alternatively, the commodity for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement. Cash settlement is a method of settling a futures contract whereby the parties effect final settlement when the contract expires by paying/receiving the loss/gain related to the contract in cash, rather than by effecting physical sale and purchase of the underlying reference commodity at a price determined by the futures contract.

Current financial instrument trading systems allow traders to submit orders and receive confirmations, market data, and other information electronically via a network. These “electronic” marketplaces have largely supplanted the pit-based trading systems whereby the traders, or their representatives, all physically stand in a designated location (i.e., a trading pit) and trade with each other via oral and hand-based communication. Anyone standing in or near the trading pit may be privy to the trades taking place (e.g., both who is trading and what they are trading) allowing, for example, one participant to derive and/or undermine another participant's trading strategy and thereby garner an unfair advantage or otherwise skew the market. Electronic trading systems, by contrast, ideally offer a more efficient, fair and balanced market where market prices reflect a true consensus of the value of traded products among the market participants, where the intentional or unintentional influence of any one market participant is minimized if not eliminated, and where unfair or inequitable advantages with respect to information access are minimized if not eliminated.

Typically, the Exchange provides for a centralized “Clearing House” through which all trades made must be confirmed, matched, and settled each day until offset or delivered. The Clearing House is an adjunct to the Exchange, and may be an operating division of the Exchange, which is responsible for settling trading accounts, clearing trades, collecting and maintaining performance bond funds, regulating delivery, and reporting trading data. The essential role of the Clearing House is to mitigate credit risk. Clearing is the procedure (also known as novation) through which the Clearing House becomes buyer to each seller of a futures contract and seller to each buyer, and assumes responsibility for protecting buyers and sellers from financial loss due to breach of contract by assuring performance on each contract. A clearing member is a firm qualified to clear trades through the Clearing House.

As an intermediary, the Exchange bears a certain amount of risk in each transaction that takes place. To that end, risk management mechanisms protect the Exchange via the Clearing House. The Clearing House establishes clearing level performance bonds (margins) for all Exchange products and establishes minimum performance bond requirements for customers of Exchange products. A performance bond, also referred to as a margin, is the funds that must be deposited by a customer with his or her broker, by a broker with a clearing member, or by a clearing member with the Clearing House for the purpose of insuring the broker or Clearing House against loss on open futures or options contracts. This is not a partial payment on a purchase. The performance bond helps to ensure the financial integrity of brokers, clearing members, and the Exchange as a whole. The performance bond to Clearing House refers to the minimum dollar deposit which is required by the Clearing House from clearing members in accordance with their positions. Maintenance, or maintenance margin, refers to a sum, usually smaller than the initial performance bond, which must remain on deposit in the customer's account for any position at all times. The initial margin is the total amount of margin per contract required by the broker when a futures position is opened. A drop in funds below this level requires a deposit back to the initial margin levels (i.e., a performance bond call). If a customer's equity in any futures position drops to or under the maintenance level because of adverse price action, the broker must issue a performance bond/margin call to restore the customer's equity. A performance bond call, also referred to as a margin call, is a demand for additional funds to bring the customer's account back up to the initial performance bond level whenever adverse price movements cause the account to go below the maintenance.

The accounts of individual members, clearing firms, and non-member customers doing business through the Exchange must be carried and guaranteed to the Clearing House by a clearing member. As described above, in every matched transaction executed through the Exchange's facilities, the Clearing House is substituted as the buyer to the seller and the seller to the buyer, with a clearing member assuming the opposite side of each transaction. The Clearing House is an operating division of the Exchange, and all rights, obligations, and/or liabilities of the Clearing House are rights, obligations, and/or liabilities of the Exchange. Clearing members assume full financial and performance responsibility for all transactions executed through them and all positions they carry. The Clearing House, dealing exclusively with clearing members, holds each clearing member accountable for every position it carries regardless of whether the position is being carried for the account of an individual member, for the account of a non-member customer, or for the clearing member's own account. Conversely, as the contra-side to every position, the Clearing House is held accountable to the clearing members for the net settlement from all transactions on which it has been substituted as provided in the Rules.

As the amounts required by the Clearing House to be on account to cover a margin requirement may be significant and may reduce the amount of funds available to the account holder for other purposes, it is desirable to minimize the margin requirement when possible without otherwise compromising the adequacy of protection afforded to the Exchange.

### BRIEF DESCRIPTION OF THE DRAWINGS

FIG. 1 depicts an illustrative computer network system that may be used in accordance with the present teachings

FIG. 2 depicts a block diagram of an exemplary implementation of the system of FIG. 1 for administering futures contracts in accordance with the present teachings

FIG. 3 depicts a flow chart showing operation of the system of FIGS. 1 and 2.

FIG. 4 shows an illustrative embodiment of a general computer system for use with the system of FIGS. 1 and 2.

FIG. 5 shows a flow chart depicting exemplary operation in accordance with the present teachings.

FIG. 6 depicts a block diagram of the process implemented by the system of FIG. 2.

FIG. 7 shows a graph of HVarR margin vs. HVaR standard deviation showing the relationship therebetween.

FIGS. 8 and 9 show graphs of SPAN margin vs. standard deviation for HVaR scenarios and 1-day un-scaled scenarios.

FIG. 10 shows a graph depicting the difference between margin vs. sum of variance and margin vs. sum of standard deviation.

FIG. 11 shows a histogram demonstrating the savings for test portfolios realized in accordance with the present teachings.

FIGS. 12 and 13 show tables depicting the five portfolios with the best and worst savings as realized by exemplary execution in accordance with the present teachings.

FIG. 14 shows a graph of the standard deviation reduction vs. savings for the test portfolios of FIG. 12.

FIG. 15 shows a distribution of the difference between exact and approximate HVaR margin.

FIG. 16 shows a chart depicting savings distribution for various percentiles.

FIG. 17 shows a chart depicting savings distribution for various HVaR SPAN coefficients.

FIG. 18 shows a table depicting exemplary portfolios.

FIGS. 19 and 20 show graphs depicting exact vs. approximate savings.

FIG. 21 shows a chart depicting a long “tail” in an IRS+optimal futures scenario distribution.

### DETAILED DESCRIPTION

By way of general introduction, embodiments in accordance with the present teachings relate to reducing, minimizing or otherwise optimizing margin requirements for a trader having both an interest rate (IR) futures and over-the-counter (OTC) interest rate swaps (IRS) accounts by efficiently allocating IR futures across both accounts.

In some embodiments, market and position data are used to determine the optimal allocation of IR futures and OTC IR swaps for designated accounts. In some embodiments, the CME Clearing House will provide this functionality as an “optimization tool,” which implements an optimization algorithm as described herein, which can be installed to run on a firm's back office systems. In some embodiments, the output of the optimization tool will be a net change in each contract to be transferred.

One way in which to determine which futures contracts to transfer is via brute force—namely, by trying all possible combinations of transfers, computing the total margin, and selecting the lowest. However, the computational time associated with such a brute force method can be enormous for precise calculations. Thus, in some embodiments, an optimization algorithm in accordance with the present teachings approximates margins (e.g., using minimum total standard deviation methods, minimization of total conditional value at risk via linear programming, etc.) in order to calculate transfers more quickly. By way of example, in some embodiments, a minimum total standard deviation method uses an approximation to margin that can be quickly computed at each stage of optimization, thereby facilitating a more intelligent search for the minimum and reducing computational time, which in turn makes the computational problem feasible.

Currently, any Clearing Member that wishes to clear both OTC IRS and IR futures must undertake a multi-step manual process to achieve margin efficiencies across these two sets of products. This manual process must be repeated for each entity related to, or whose positions are cleared by, the clearing member. A Clearing House is actually composed of two silos—an IRS silo and a futures silo—and, desirably, futures positions will optimally be allocated across both silos.

Additionally, there are negative consequences associated with misallocating positions across the two accounts. In fact, if done improperly, misallocating positions can result in higher margins than the base case (i.e., futures margined by themselves and swaps margined by themselves). The current solutions do not properly scale in such a way that they can be extended to thousands of accounts in a fully automated way on a daily basis (or more frequently if desired). For example, current mechanisms will typically employ a business analyst for data aggregation, a quantitative analyst for computing optimized allocation of futures positions, and an operations analyst for inputting the resulting transfers into a graphical user interface (GUI). Due to the substantial overhead associated with current mechanisms such as this, an end user generally cannot optimize/rebalance a portfolio on a daily basis, thereby forgoing potential savings. In addition, the entry of transfers into the GUI by the operations analyst is susceptible to human user error (e.g., omission, mis-keys, etc.). Moreover, the operations analyst will typically have to enter both sides of any transfer trade (e.g., the buy transaction and the offsetting sell transaction) into the GUI for potentially dozens of contracts. Each side of the transaction can take approximately 30 seconds, which—from the point of view of trade processing alone—will correspond to about one minute per contract. Thus, without proper automation, only an extremely small subset of the universe of entities participating in these two markets would be able to realize initial margin capital efficiencies.

By contrast to current mechanisms, an optimization tool in accordance with the present teachings, as further described herein, can be used for automatically generating transfer messages that can be sent to, by way of example, CME Clearing's trade processing system and processed in a matter of seconds. Clearly, automation in accordance with the present teachings can result in significant savings in man-hours, particularly when scaled up to hundreds or thousands of portfolios. Moreover, an optimization tool in accordance with the present teachings can ensure accuracy of the transfers by programmatically generating them according to the results of the optimization as opposed to relying upon entry of the transfers into a GUI by an operations analyst which, as noted above, is susceptible to human user error.

In some embodiments, the accuracy and speed of initial margin balancing across multiple accounts/products is improved. As some Clearing Houses, such as the Clearing House of the CME, referred to as “CME Clearing,” may support customer Portfolio Margining (PM), traders and/or trading firms (referred to herein as “firms”) may desire an “optimization tool” that can perform functions as described below.

By way of introduction, in some embodiments, a process for minimizing a margin requirement of a trader holding first and second accounts, the first and second accounts being characterized by a combined margin requirement, comprises the following acts: (1) receiving data representative of a first plurality of positions in the first account and a second plurality of positions in the second account; (2) determining an optimal reallocation of the first and second plurality of positions between the first and second accounts which results in a total margin requirement for the first and second accounts that is less than the combined margin requirement; (3) determining one or more modifications to the plurality of positions of the first account, the second account, or a combination thereof to achieve the determined optimal reallocation; and (4) generating a set of proposed transactions to effect the determined one or more modifications. In some embodiments, the process for minimizing a margin requirement as described above is implementable by an optimization tool, as further described below.

In act (1) of a method in accordance with the present teachings, data representative of a first plurality of positions in the first account and a second plurality of positions in the second account are received (e.g., in a single system). All relevant data elements (e.g., such as market and position data provided by firms) can be gathered and loaded into a single system (e.g., an optimization tool). These data elements can include but are not limited to the delta ladder file, Standard Portfolio Analysis of Risk (SPAN) file, futures position file, base curve file, scaled log return file, or the like, and combinations thereof. Some of the data files that may be needed for proper processing are summarized in Table 1 below. In some embodiments, the optimization tool receives—vis-à-vis the “futures position file”—the customer's regular futures positions residing in a 4(d) account, the customer's swap and futures positions residing in a Portfolio Margin 4(d)(f) account, and a mapping table that maps 4(d), 4(d)(f) and delta ladders together by client.

TABLE 1

| | |
|---|---|
| Delta Ladder | This file may be generated on a nightly basis from the |
| | CME IRS back-office processing system. A delta |
| | ladder is an IRS portfolio expression of risk to the |
| | optimization tool for a given performance bond |
| | (“PB”) account (client). One-to-many curves per PB |
| | account will be created within each delta ladder file. |
| Composite | This file contains the composite delta and settlement |
| Delta/SPAN | price statistics for every active Eurodollar and |
| | Treasury futures/options contract that may be |
| | contained within a client's portfolio. |
| Scaled Log | This file is a data file created nightly from the CME |
| Returns | IRS back-office processing system that is used as part |
| | of the margin/savings approximation process in the |
| | algorithm |
| Base Curve | This file contains the base curves, FX rates, futures |
| | data, and pricing used by the optimization tool to |
| | calculate risk offsets of Eurodollar and Treasury |
| | futures against IRS. |
| Positions | This file contains the current allocation of futures |
| | within a client's PM account and futures/options |
| | contracts contained within the segregated (SEG) |
| | account. This file may also link each PM and SEG |
| | account back to their corresponding PB account. |
| | There may be only 1 PM account per PB account and |
| | only 1 SEG (or NSEG) account per PB account. |

In some embodiments, the market data to be loaded into an optimization tool in accordance with the present teachings can include but are not limited to delta ladder per performance bond (PB) account (client) sent from the CALYPSO® (i.e., the OTC clearing application), composite delta for every active Eurodollar and Treasury option contract which may be parsed from a SPAN file, current settlement prices for eligible futures contracts which may be parsed from a SPAN file, prior day settlement prices for eligible futures contracts which may be parsed from a SPAN file, scaled log return file, base curve file, or the like, and combinations thereof. In some embodiments, the data can include but are not limited to data representative of an expression of risk for a margin account of the trader, composite delta statistics for every position which may be contained in the first account, OTC IRS data from an OTC IRS clearing system, base curves, foreign exchange rates, futures data and pricing for computation of risk offsets of Eurodollar and Treasury futures, a current allocation of futures within a PM account and futures/options contracts within the futures position segregated (SEG) account, or the like, and combinations thereof. In some embodiments, when the first account comprises an interest rate futures account, the positions therein can include Eurodollar futures, Eurodollar options, Treasury futures, Treasury options, or the like, and combinations thereof.

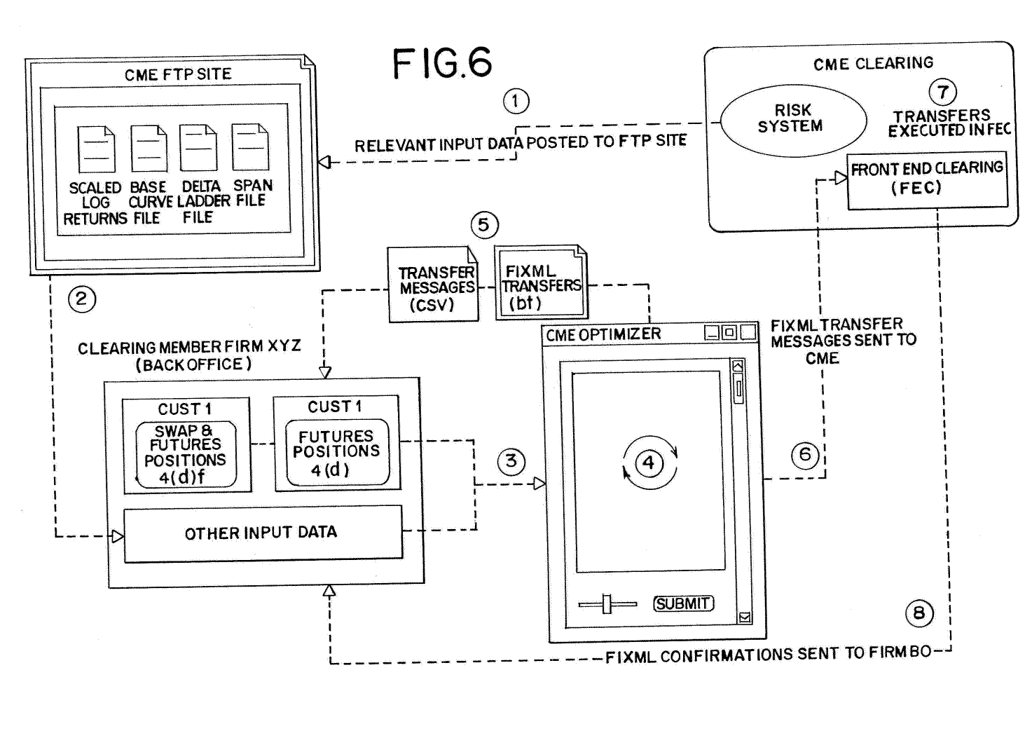

As shown in FIG. 6, in some embodiments, CME can post all relevant input data to a CME FTP site \textcircled{1}. Clearing members can pull in data—which can include the delta ladder file, span file, futures position file, base curve file, scaled log return file, and/or the like—from the CME FTP site \textcircled{2}. By way of example, position and input data loaded into the CME optimization tool \textcircled{3} can include but are not limited to customer's regular futures positions residing in a 4(d) account (Eurodollars need to be longs and shorts by contract; Treasuries need to be longs and shorts by trade date by contract), futures positions residing in a PM 4(d)f account, and other input data from CME FTP sites.

Upon being launched, the optimization tool can sweep the specified input directory for the data files to process. The location of the input directory may be specified within a configuration file.

In act (2) of a method in accordance with the present teachings, an optimal reallocation of the first and second plurality of positions between the first and second accounts, which results in a total margin requirement for the first and second accounts that is less than the combined margin requirement, is determined. In some embodiments, the optimal reallocation comprises determining the optimal allocation of interest rate futures across an entity's swaps account and futures account. In some embodiments, an optimization algorithm in accordance with the present teachings can be run for each portfolio to determine the optimal allocation of interest rate futures positions across two accounts. The optimization algorithm can be implemented in a number of different ways, with one representative and non-limiting example being an algorithm that relies on a measure of volatility as a sufficient proxy for initial margin to determine the optimal allocation.

As shown in FIG. 6, in some embodiments, the optimization tool will identify the optimal allocation of available cross-margin opportunities \textcircled{4}. Once the data are read into the optimization tool and parsed, the optimization tool may process the data and calculate what transfers (if any) can be made to improve the allocation of futures to take advantage of the Exchange's portfolio margining program. The optimization tool may be capable of processing multiple portfolios (PB accounts and associated PM and SEG accounts) in batch. Thus, multiple portfolios may be represented in the delta ladder and positions input files.

In act (3) of a method in accordance with the present teachings, one or more modifications to the plurality of positions of the first account, the second account, or a combination thereof that will achieve the determined optimal reallocation are themselves determined. In some embodiments, the net change needed to change each position in each account to match the optimal allocation is deduced. Given the result from act (2) and the initial allocation of positions from act (1), the net positions to transfer to and from each account for each contract for each client can be deduced. As shown in FIG. 6, in some embodiments, the optimization tool can deduce the net change in each contract to be transferred \textcircled{4} (e.g., net contract for Eurodollars and Treasuries).

In act (4) of a method in accordance with the present teachings, a set of proposed transactions to effect the determined one or more modifications are generated. Once the optimal allocation of futures has been found, transfer messages to rebalance the relative positions on the books of the Clearing House can be created. In some embodiments, the transfer message comprises a FIXML transfer message. In some embodiments, the optimization tool will output 2 files: a .csv summary file to summarize the changes that took place and a FIXML file containing associated transfer messages to effect the changes from act (3) on the clearing house's books.

As shown in FIG. 6, in some embodiments, the optimization tool will generate a comma separated value (.csv) file and a text (.txt) file (e.g., FIXML) with transfer messages that may be used by the clearing member firm to process transfers, which may require contract trade dates \textcircled{5}. In some embodiments, the optimization tool creates FIXML transfer messages which can be sent to CME via MQ (or other communication methods) to front end clearing (FEC) {circle around (\tilde{6}. In such embodiments, the firms will already have setup their systems to send the FIXML messages to the Exchange (e.g., CME) via MQ. As further shown in FIG. 6, in some embodiments, transfers are automatically executed in FEC \textcircled{7}. In some embodiments, FIXML confirmations are sent to clearing member back office \textcircled{8}.

In some embodiments, there will be one .csv and one FIXML file created per execution of the optimization tool. By way of example, if the delta ladder and positions files contain five separate portfolios within them, there will be a single .csv and FIXML output containing optimized position allocations for five portfolios. In some embodiments, the FIXML file is in a format ready to be sent to the Exchange (e.g., CME) for clearing.

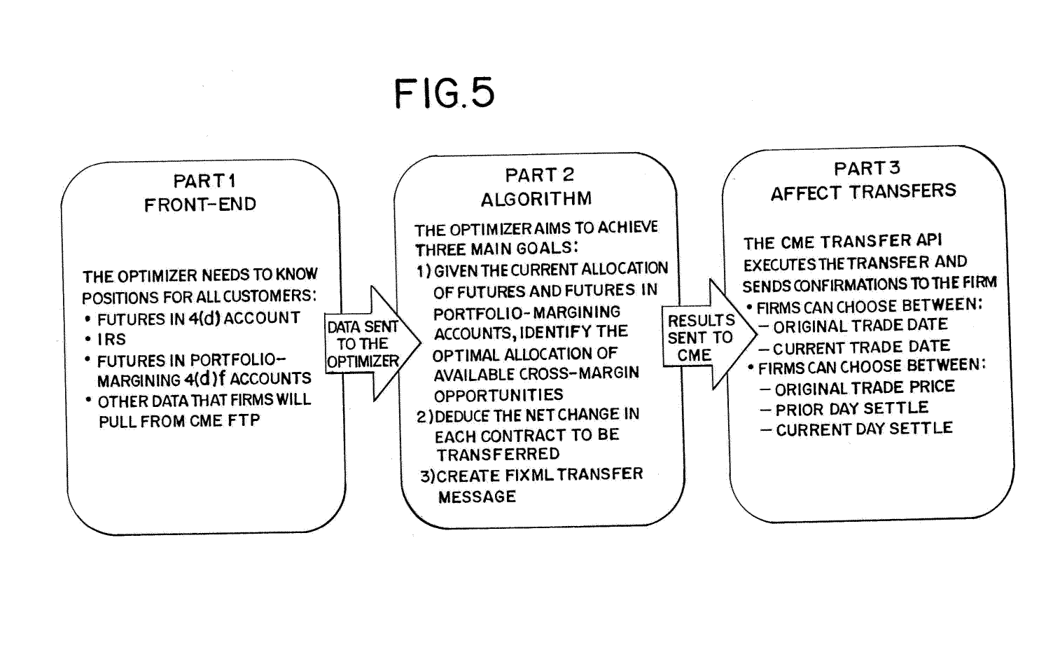

In some embodiments, an optimization software application—which may be installed to run on a firm's back office systems, thereby creating a substantial cost savings—is provided. This new tool may allow exchanges, such as CME, to ensure that customers can achieve the most margin savings through the PM offering. FIG. 5 shows a flow chart depicting exemplary operation of a tool in accordance with the present teachings.

In some embodiments, firms may be responsible for providing the optimization tool with the proper inputs and sending the FIXML transfer messages to CME Clearing (as well as installing the optimization tool to run on their back office systems). In some embodiments, the Exchange may only be responsible for executing transfers after receiving the firms' instructions.

In some embodiments, for each participating customer of the Exchange in the PM program, the disclosed embodiments may further be able to house position level data including but not limited to: trade level details for each contract residing in the customer's PM 4(d)f account, such as position, original trade date, and original trade price; and trade level details for each Treasury (2, 5, 10, Bond) and Eurodollar futures and options contracts residing in the customer's regular Futures 4(d) account, such as position, original trade date, and original trade price.

For each customer participating in the PM program, the optimization algorithm in accordance with the present teachings, described in more detail below, may have the ability to identify the total long positions in each eligible futures contract and/or total short positions in each eligible futures contract. Furthermore, the algorithm may have the ability to solve for the optimal net position in each eligible futures contract where the customer has positions (e.g., total long and short positions in each eligible futures contract).

In some embodiments, users can configure transfer assumptions by product. A first configuration comprises original trade date and/or current trade date depending on the contract. A second configuration comprises original trade price and/or current day settle depending on the contract. A third configuration comprises FIFO (First In, First Out) or LIFO (Last In, First Out), thus deducing not only the net position but also the precise trades to move for a given contract based on their date of execution.

In some embodiments, an exemplary Transfer Add Message to the Exchange (e.g. CME) may take the following form when initiating a trade transfer via a suitable application program interface (API): add transfer (TrdTyp=“3”) with original trade date (OrigTrdDt) and Transfer Reason Code (OrdTyp)=“M”:

<FIXML>
<TrdCaptRpt MsgEvtSrc=“API” TrdHandlInst=“0” RptID=“0012217”
TransTyp=“3” TxnTm=“2012-02-27T09:06:23-06:00” TrdDt=“2012-02-
27” BizDt=“2012-02-27” RptTyp=“0” MLegRptTyp=“1” TrdTyp=“3”
OrigTrdDt=“2012-02-24” LastQty=“75.00” LastPx=“98.82000000”
TrdID=“0010099”>
<Hdr Snt=“2012-02-27T09:06:23-06:00” SSub=“CME” TSub=“CME”
SID=“999” TID=“CME”/>
<Instrmt Exch=“CME” ID=“ED” CFI=“FXXXXX” MMY=“201412”
SecTyp=“FUT”/>
<RptSide CustCpcty=“2” Side=“1” ClOrdID=“0059” SesID=“RTH”
InptDev=“API” OrdTyp=“M” SesSub=“X”>
<Pty ID=“CME” R=“22”/>
<Pty ID=“909” R=“17”/>
<Pty ID=“CME” R=“21”/>
<Pty ID=“999” R=“1”/>
<Pty ID=“IRS_XMGRN” R=“24”>
<Sub ID=“1” Typ=“26”/>
</Pty>
</RptSide>
</TrdCaptRpt>
</FIXML>

The Exchange (e.g. CME Clearing) may acknowledge the update by sending the trade capture report acknowledgement message to the Clearing Member firm.

A exemplary exchange acknowledgement of the optimization tool Add Transfer Message may be sent from the Exchange (e.g. CME) back to Clearing Member firm, with TransTyp=“0”:

<FIXML>
<TrdCaptRptAck RptID=“135BCD40D95AP0001C1B6132021144”
TransTyp=“0” RptTyp=“0” TrdTyp=“3” TrnsfrRsn=“C”
MtchID=“135BCD40D95AP0001C1B4”
ExecID=“00000000000000000045” PxTyp=“2” TrdDt=“2012-02-24”
BizDt=“2012-02-24” MLegRptTyp=“1” MtchStat=“1”
MsgEvtSrc=“CMESys” RptRefID=“0012217” TrdRptStat=“0”
TrdID=“10099” TrdID2=“135BCD40D95AP0001C1B6”
TrdHandlInst=“2” OrigTrdDt=“2012-02-24” LastQty=“75”
LastPx=“98.82000000” TxnTm=“2012-02-27T13:20:21-06:00”>
<Hdr Snt=“2012-02-27T13:20:21-06:00” SID=“CME” TID=“999”
SSub=“CME” TSub=“CME”/>
<Instrmt Sym=“GEZ4” ID=“ED” CFI=“FFDCSO” SecTyp=“FUT”
Src=“H” MMY=“20141200” MatDt=“2014-12-15” Mult=“2500”
Exch=“CME” PxQteCcy=“USD”/>
<RptSide Side=“1” ClOrdID=“0059” InptSrc=“MQM” InptDev=“API”
CustCpcty=“2” OrdTyp=“M” SesID=“RTH” SesSub=“X”>
<Pty ID=“CME” R=“21”/>
<Pty ID=“CME” R=“22”/>
<Pty ID=“999” R=“1”/>
<Pty ID=“IRS_XMGRN” R=“24”>
<Sub ID=“1” Typ=“26”/>
</Pty>
<Pty ID=“909” R=“17”/>
<Pty ID=“999” R=“4”/>
<Pty ID=“IRS_XMGRN” R=“38”>
<Sub ID=“1” Typ=“26”/>
</Pty>
</RptSide>
</TrdCaptRptAck>
</FIXML>

In some embodiments, a process that can be described as “portfolio margining of interest rate swaps and interest rate futures for house accounts” or “customer portfolio margining” is provided. Such processes may allow a Clearing House and clearing members, such as CME Clearing and the clearing members thereof, to recognize reduced risks associated with offsetting open positions, along with potential benefits that may include but are not limited to: reduced margin requirements for portfolios containing both products; reduced regulatory capital costs for FCMs; and/or reduced guaranty fund requirements for FCMs.

Customer portfolio margining may leverage the current 5-day, multi-currency historical value at risk (VaR) framework, applying this methodology to Eurodollar and Treasury futures prices. Because it is a 5-day model, it is desirable to choose the correct futures positions to commingle with IRS positions otherwise commingling could lead to an increased margin requirement for the portfolios. In some embodiments, clearing member firms receive margins based on this method. In some embodiments, an optimization tool that is further described below, based on certain inputs, can derive the optimal allocation of futures positions between an entity's futures account and swaps account. In some embodiments, transfer messages may also be created that are compatible with FEC to effect those transfers on the books and records of the Clearing House. In some embodiments, customers can achieve the most advantageous margin savings while automating the process of selecting which adjustments to make and generating transfer messages to effect those adjustments.

Although trade execution workflows in OTC IRS and IR futures will remain the same, there may be impacts to other processes (e.g., account setup, position management, margin service, etc.).

The Exchange (e.g., CME) may support netting eligibility for Eurodollar (ED) futures, Treasury futures, and IRS margin calls at a customer level. Representative products that may be utilized for customer portfolio margining include but are not limited to all OTC interest rate swaps and IR futures found in Table 2 below.

TABLE 2

| | | | | Clear- |
|---|---|---|---|---|
| | | | | ing |
| | | Ex- | | House |
| Name | Product Type | change | CME Codes | Codes |
| Eurodollar | Eurodollar | CME | Open Outcry = ED | ED |
| Future | Futures | | CME Globex = GE | |
| U.S. Treasury | U.S. Treasury | CBOT | Open Outcry = US | 17 |
| Bond | Futures | | CME Globex = ZB | |
| 10-Year U.S. | U.S. Treasury | CBOT | Open Outcry = TY | 21 |
| Treasury Note | Futures | | CME Globex = ZN | |
| 5-Year U.S. | U.S. Treasury | CBOT | Open Outcry = FV | 25 |
| Treasury Note | Futures | | CME Globex = ZF | |
| 2-Year U.S. | U.S. Treasury | CBOT | Open Outcry = TU | 26 |
| Treasury Note | Futures | | CME Globex = ZT | |

In some embodiments, an optimization tool is provided, which may accept as inputs various CME-produced data files as well as firm-produced files outlining the current allocation of a portfolio's futures positions to be cross margined with IRS, and recommend a more optimal allocation to improve margin requirements. In some embodiments, the optimization tool may be implemented as logic stored in a memory and executable by a processor or otherwise as computer readable instructions stored in a non-transitory medium. In some embodiments, the optimization tool may be implemented so as to be able to run in batch, therefore processing multiple portfolio allocations through each run. In some embodiments, the optimization tool may also generate and provide transfer message files (such as in FIXML format) if a futures clearing member (FCM) would like to execute the recommended transfers at the end of each day. This may translate into a substantial cost savings for clients who clear at CME.

In some embodiments, the optimization tool can operate as described below.

Upon being launched, the optimization tool may sweep the specified input directory for the data files to process. The location of the input directory may be specified within a configuration file. Once the data is read into the optimization tool and parsed, the optimization tool may process the data and calculate what transfers (if any) can be made to improve the allocation of futures to take advantage of the Exchange's PM program. In some embodiments, the optimization tool may be capable of processing multiple portfolios (PB accounts and associated PM and SEG accounts) in batch. Therefore, multiple portfolios may be represented in the delta ladder and positions input files.

In some embodiments, once the optimal allocation of futures has been found, the optimization tool will output 2 files: a .csv summary file, and a FIXML file containing associated transfer messages. In some embodiments, there will be one .csv and one FIXML file created per execution of the optimization tool. By way of example, if the delta ladder and positions files contain five separate portfolios within them, there will be a single .csv and FIXML output containing optimized position allocations for five portfolios. In some embodiments, the FIXML file is in a format ready to be sent to CME for clearing.

In some embodiments, in order to decrease run times, logging may be set to a minimum level by default. At the minimum logging level, only error messages will be recorded within the log file. In some embodiments, there may be two levels of errors: portfolio errors and processing errors. Portfolio level errors occur when there is a problem with data associated with a specific portfolio (e.g., a future is listed in a positions file that is not found). In the case of portfolio level errors, the optimization tool may log the error encountered, skip any remaining calculation for the problematic portfolio, and continue processing for the next given portfolio. Processing level errors occur when there is a problem with data associated with the overall execution of the optimization tool (e.g., the base curves file is not found). In the case of processing level errors, the optimization tool may log the error encountered and stop processing for all portfolios.

In some embodiments, the configuration file is read at run time and allows a user to customize the use of their installation of the optimization tool. Representative configurations currently available in the configuration file are shown in Table 3 below

TABLE 3

| Parameter Name | Description | XML Tag | Allowable Values | Default Value |
|---|---|---|---|---|
| HVAR SPAN | Used to scale HVAR scenarios. | <hvarSpanCoef> | N/A - This shouldn't change. | .2 |
| Coefficient | | | | |
| Verbosity | Controls the amount of output | <verbosityLevel> | 1-10 | 5 |
| | the algorithm writes. | | | |
| Transfer Allocation | This parameter will determine how | <moveDecision> | LIFO: Last in First Out | LIFO |
| Method | to build transfer messages in order | | FIFO: First in First Out | |
| | to reach optimal futures allocation. | | | |
| Input Directory | Identifies the location that all | <inputFileDirectory> | Any directory location. If empty, | Empty |
| Location | the input files will be swept from. | | defaults to the directory of the | |
| | | | optimization tool executable. | |
| Output Directory | Identifies the location that all | <outputFileDirectory> | Any directory location. If empty, | Empty |
| Location | the output files will be saved to. | | defaults to the directory of the | |
| | | | optimization tool executable. | |
| Portfolio Error | Determines how to handle portfolio | <portfolioErrorHandling> | STOP: Stops processing | SKIP |
| Handling Method | level errors | | SKIP: Skips the errant portfolio | |
| | | | and continues processing | |
| Debug mode | Determines the amount of logging | <debugMode> | 0: Minimum logging | 0 |
| execution | messages to be written to the log file. | | 1: Verbose logging | |
| FIXML filename | The name that should be given to | <filenameFixmlOutput> | Any filename | fixmlTransfers.xml |
| | the FIXML output file. | | | |
| CSV filename | The name that should be given to | <filenameCsvOutput> | Any filename | csvTransfers.csv |
| | the CSV output file. | | | |
| Partial name for | Identifies the name of the file to | <partialfilenamePosition> | Any string | Positions |
| the Positions file | be used to find the positions file. | | | |
| | The optimization tool will search | | | |
| | for file names with this string | | | |
| | contained within the name. | | | |
| Partial name for | Identifies the name of the file to | <partialfilenameSpanRiskArray> | Any string | cme.c.spn |
| the SPAN Risk | be used to find the SPAN risk array | | | |
| Array file | file. The optimization tool will | | | |
| | search for file names with this | | | |
| | string contained within the name. | | | |
| Partial name for | Identifies the name of the file to | <partialfilenameBaseCurve> | Any string | Base_Curves |
| the Base Curves | be used to find the base curve file. | | | |
| file | The optimization tool will search for | | | |
| | file names with this string contained | | | |
| | within the name. | | | |
| Partial name for | Identifies the name of the file to | <partialfilenameLogReturn> | Any string | Log_Return |
| the Scaled Log | be used to find the scaled log return | | | |
| Returns file | file. The optimization tool will | | | |
| | search for file names with this string | | | |
| | contained within the name. | | | |
| Partial name for | Identifies the name of the file to | <partialfilenameSwapDeltaLadder> | Any string | delta_ladder |
| the Delta Ladder | be used to find the delta ladder | | | |
| file | file. The optimization tool will | | | |
| | search for file names with this | | | |
| | string contained within the name. | | | |
| Transfer Message | Input to the transfer message. | <fixmlTrdCaptRptMsgEvtSrc> | N/A - This shouldn't change. | API |
| Source | | | | |
| Transfer Message | Input to the transfer message. | <fixmlInstrmtCfi> | N/A - This shouldn't change. | FXXXXX |
| CFI tag | | | | |

In some embodiments, clearing members will set up WINDOWS® or ACTIVEBATCH® scheduled processes to pull the needed input data files and write them to the input directory file. In some embodiments, clearing members may have another scheduled process to execute the optimization tool on a frequent basis. In some embodiments, clearing members may have a scheduled process to sweep the output directory, pull the FIXML transfer message file, and submit it to CME for clearing. In setting up this process, the cleanup of the input and output directories can be considered. If the optimization tool finds multiple files within the input directory with the same partial filename (listed in the configuration file) the optimization tool will use the file with the most recent modified date.

In some embodiments, the optimization tool may be executed on demand by simply dragging-and-dropping files and double-clicking an executable file (e.g., optimizer.exe).

In some embodiments, file inputs from the Exchange (e.g., CME Group) file transfer (e.g., FTP) site may follow the below service level agreements (SLA):

| Report | SLA (EST) |
|---|---|
| Base Curve | 7:00PM EST |
| Log Returns | 7:00PM EST |
| Delta Ladder | 7:15PM EST |
| SPAN | 7:15PM EST |

In some embodiments, the fifth input file is the positions file, which contains all positions associated with the PM and SEG (or NSEG, if for the clearing member's proprietary positions) accounts. An exemplary format is provided in Table 4 below.

TABLE 4

| | | | “Futures & | | | | | | | | | | |
|---|---|---|---|---|---|---|---|---|---|---|---|---|---|
| | | | Options | | | | | Call | | | | | |
| | | Futures & | Account | | | | Future | “C” | | | | | |
| | | Options | Type | | | Option | (Underlying) | or | | | | | |
| PB Account | | Account | (SEG vs. | Product | Product | Expiration | Expiration | Put | | Total | Total | Trade | Exchange |
| ID | TMF ID | ID | PM)” | Code | Type | Month | Month | “P” | Strike | Long | Short | Date | Code |
| 123 | AAA | 111 | SEG | 21 | OOF | 201208 | 201209 | C | 130 | 100 | 0 | 20120702 | CBT |
| 123 | AAA | 111 | SEG | 21 | OOF | 201208 | 201209 | C | 135 | 200 | 0 | 20120703 | CBT |
| 123 | AAA | 111 | SEG | 21 | OOF | 201208 | 201209 | C | 140 | 0 | 50 | 20120706 | CBT |
| 123 | AAA | 111 | SEG | 21 | FUT | | 201209 | | | 0 | 300 | 20120702 | CBT |
| 123 | BBB | 222 | PM | 21 | FUT | | 201209 | | | 0 | 200 | 20120703 | CBT |
| 123 | BBB | 222 | PM | 25 | FUT | | 201209 | | | 200 | 0 | 20120702 | CBT |
| 789 | ZZZ | 333 | NSEG | 25 | FUT | | 201209 | | | 400 | 0 | 20120703 | CBT |
| 789 | ZZZ | 333 | NSEG | 25 | FUT | | 201209 | | | 700 | 0 | 20120706 | CBT |
| 789 | ZZZ | 333 | NSEG | ED | FUT | | 201306 | | | 0 | 400 | | CME |
| 789 | ZZZ | 444 | PM | ED | FUT | | 201209 | | | 100 | 0 | | CME |
| 789 | ZZZ | 444 | PM | ED | FUT | | 201212 | | | 0 | 300 | | CME |
| 789 | ZZZ | 444 | PM | ED | FUT | | 201303 | | | 300 | 0 | | CME |
| 789 | ZZZ | 444 | PM | ED | FUT | | 201309 | | | 500 | 0 | | CME |
| 789 | ZZZ | 444 | PM | ED | FUT | | 201312 | | | 700 | 0 | | CME |

The specifications of each field are provided in Table 5 below.

TABLE 5

| Column | | |
|---|---|---|
| Name | Size | Description |
| PB Account | Up to 15 alpha-numeric | This is the CME PB account |
| ID | | ID that is linked to the F&O |
| | | account ID of this position. |
| | | This ID ties to the PB account |
| | | ID displayed in the delta |
| | | ladder file. |
| TMF ID | Up to 5 alpha-numeric | TMF ID associated with the |
| | | position |
| Futures & | Up to 15 alpha-numeric | This is the futures/options |
| Options | | account ID associated with |
| Account ID | | this position. |
| “Futures & | Up to 15 alpha-numeric | This field identifies if this |
| Options | | futures/options account ID |
| Account | | associated with this position |
| Type (SEG vs. | | should be included in the PM |
| PM)” | | program. SEG: segregated |
| | | customer futures & options |
| | | account (4d account); NSEG: |
| | | segregated house futures & |
| | | options account (4d account); |
| | | PM: futures account that is |
| | | part of the portfolio margining |
| | | program (4df account). |
| | | *N.B. a PB account ID can |
| | | only have at most 1 PM |
| | | account and 1 SEG account |
| | | associated with it. If it |
| | | is a house account, this will |
| | | be understood by the SEG |
| | | account being listed as |
| | | NSEG.” |
| Product Code | Up to 10 (clearing | Span Product Family Code |
| | currently 6) | |
| Product Type | 3 bytes alpha-numeric | OOF for option, FUT for |
| | | future |
| Option | 6 | Month of option expiry |
| Expiration | | (YYYYMM) |
| Month | | |
| Future | 6 | Month of future expiry |
| (Underlying) | | (YYYYMM) |
| Expiration | | |
| Month | | |
| Call “C” or | 1 | “C” for call, |
| Put “P” | | “P” for put, |
| | | blank for futures |
| Strike | Up to 14 digits, Seven | Strike - in true decimal format |
| | Left, Seven Right | |
| Total Long | Up to 15 digits, 2 | Total long positions |
| | decimals | |
| Total Short | Up to 15 digits, 2 | Total long positions |
| | decimals | |
| Trade Date | 8 | YYYYMMDD |
| SPAN | 3 | The 3-character SPAN |
| Exchange | | Exchange code. In this case, |
| | | either CME or CBT. |

*It is assumed that futures and options will be held in the same SEG account.

In some embodiments, the optimization tool may be implemented so as to be executed in a 64 bit Microsoft WINDOWS® environment having the .NET Framework 4.0 installed. Further, in some embodiments, SPAN.NET may be required, which available from CME at cme-ch.com.

In some embodiments, firms are responsible for providing the optimization tool with the proper inputs and sending the FIXML transfer messages to CME Clearing (as well as for installing the optimization tool to run on their back office systems). In some embodiments, the Exchange (e.g., CME Clearing) builds the optimization tool and is only responsible for executing transfers after receiving the firm's instructions,

The following is an exemplary Transfer Add Message which may be sent from the disclosed optimization tool to an exchange (e.g., CME) when initiating a trade transfer via API: add transfer (TrdTyp=“3”) with original trade date (OrigTrdDt) and Transfer Reason Code (OrdTyp)=“M”:

```
<FIXML>
<TrdCaptRpt MsgEvtSrc=“API” TrdHandlInst=“0” RptID=“0012217”
TransTyp=“0” TxnTm=“2012-02-27T09:06:23-06:00” TrdDt=“2012-02-
27” BizDt=“2012-02-27” RptTyp=“0” MLegRptTyp=“1” TrdTyp=“3”
OrigTrdDt=“2012-02-24” LastQty=“75.00” LastPx=“98.82000000”
TrdID=“0010099”>
        <Hdr Snt=“2012-02-27T09:06:23-06:00” SSub=“CME”
TSub=“CME” SID=“999” TID=“CME”/>
        <Instrmt Exch=“CME” ID=“ED” CFI=“FXXXXX”
MMY=“201412” SecTyp=“FUT”/>
<RptSide CustCpcty=“2” Side=“1” ClOrdID=“PM001” SesID=“RTH”
InptDev=“API” OrdTyp=“M” SesSub=“X”>
                        <Pty ID=“CME” R=“22”/>
                        <Pty ID=“909” R=“17”/>
                        <Pty ID=“CME” R=“21”/>
                        <Pty ID=“999” R=“1”/>
                        <Pty ID=“IRS_XMGRN” R=“24”>
                                <Sub ID=“1” Typ=“26”/>
                        </Pty>
                </RptSide>
        </TrdCaptRpt>
</FIXML>
```

The following is exemplary acknowledgement of the optimization tool Add Transfer Message which may be sent from the Exchange (e.g., CME) back to the clearing member firm, with TransTyp=“0”:

```
<FIXML>
<TrdCaptRptAck RptID=“135BCD40D95AP0001C1B6132021144”
TransTyp=“0” RptTyp=“0” TrdTyp=“3” TrnsfrRsn=“M”
MtchID=“135BCD40D95AP0001C1B4”
ExecID=“00000000000000000045” PxTyp=“2” TrdDt=“2012-02-24”
BizDt=“2012-02-24” MLegRptTyp=“1” MtchStat=“1”
MsgEvtSrc=“CMESys” RptRefID=“0012217” TrdRptStat=“0”
TrdID=“103650” TrdID2=“135BCD40D95AP0001C1B6”
TrdHandlInst=“2” OrigTrdDt=“2012-02-24” LastQty=“75”
LastPx=“98.82000000” TxnTm=“2012-02-27T13:20:21-06:00”>
              <Hdr Snt=“2012-02-27T13:20:21-06:00” SID=“CME”
      TID=“999” SSub=“CME” TSub=“CME”/>
      <Instrmt Sym=“GEZ4” ID=“ED” CFI=“FFDCSO”
      SecTyp=“FUT”
Src=“H” MMY=“20141200” MatDt=“2014-12-15” Mult=“2500”
Exch=“CME” PxQteCcy=“USD”/>
      <RptSide Side=“1” ClOrdID=“PM001” InptSrc=“MQM”
InptDev=“API” CustCpcty=“2” OrdTyp=“M” SesID=“RTH”
SesSub=“X”>
                              <Pty ID=“CME” R=“21”/>
                              <Pty ID=“CME” R=“22”/>
                              <Pty ID=“999” R=“1”/>
                              <Pty ID=“IRS_XMGRN” R=“24”>
                                      <Sub ID=“1” Typ=“26”/>
                              </Pty>
                              <Pty ID=“909” R=“17”/>
                              <Pty ID=“999” R=“4”/>
                              <Pty ID=“IRS_XMGRN” R=“38”>
                                      <Sub ID=“1” Typ=“26”/>
                              </Pty>
                      </RptSide>
              </TrdCaptRptAck>
      </FIXML>
```

In some embodiments, the optimization tool algorithm is designed with a few specific objectives in mind: to reduce the combined margin of the OTC and futures positions SEG accounts; to be sufficiently fast to process a large number of accounts in a typical end-of-day time window; to minimize the margin across any combination of available positions; and to be deployable, such as to customer systems or premises, and not be overly dependent on internal systems of the Exchange.

Minimizing margin directly may be an unfeasible task for a few reasons. First, the historical value at risk (HVaR) and SPAN margin algorithms are complex and cannot be approximated easily. Because of this, minimizing margin directly may require direct margin calculations. Considering the number of possible allocations of positions in each portfolio, the number of margin calculations becomes very large and thus may be very time-consuming.

By contrast, some embodiments in accordance with the present teachings focus on volatility rather than margin. Both are measures of risk in a portfolio and should in general indicate a positive relationship. Using portfolio volatility as measure of risk is a result from Markowitz portfolio theory—a theory of finance which attempts to maximize portfolio expected return for a given amount of portfolio risk or, equivalently, minimize risk for a given level of expected return, by carefully choosing the proportions of various assets. For scenario-based margin models, if the distribution of scenario portfolio changes is close enough to a normal distribution, then the volatility and margin are directly related. A benefit of minimizing volatility is that there is a function for volatility as a function of allocation. Moreover, by focusing on portfolio volatility, any instrument that reduces the portfolio volatility is accepted and the approach is not limited to matching up positions.

One approach to reducing portfolio risk is to use sensitivity-based hedging. In this approach, sensitivities to various portfolio risk factors are estimated and then the positions are adjusted such that each sensitivity becomes small. However, this approach focuses on adding new positions to reduce portfolio risk by matching instruments. Trying to adapt this to the case where existing positions are used becomes complicated as the structure of sensitivities together and their co-dependence have to be considered.

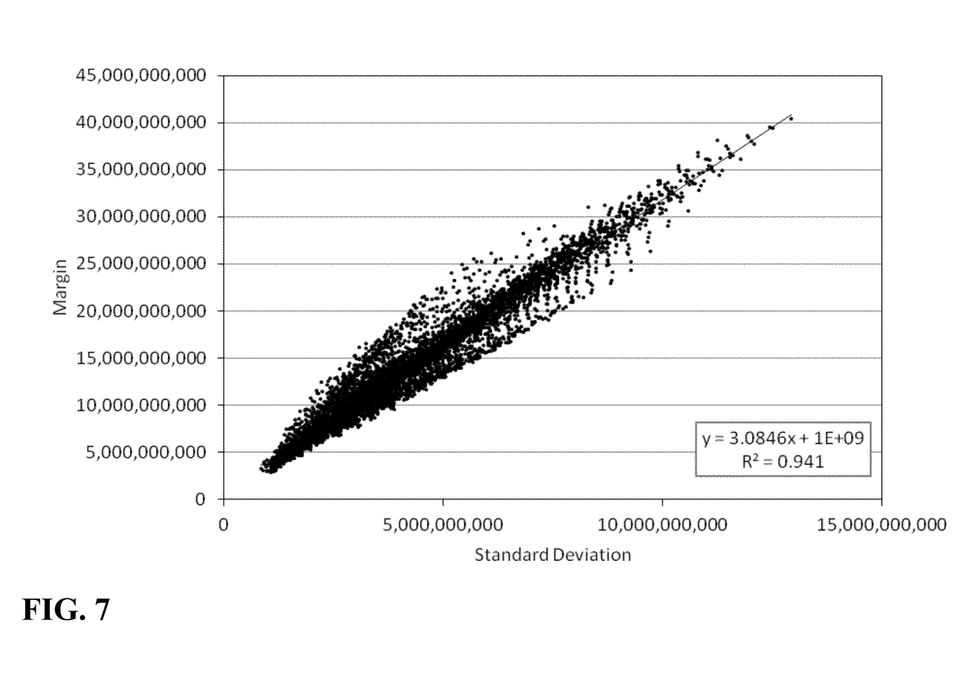

As described above, an optimization tool algorithm in accordance with the present teachings focuses on minimizing volatility. There is a natural connection between volatility and the HVaR margin algorithm. Since the HVaR margin algorithm is a scenario-based algorithm, it generates a distribution of portfolio changes. The volatility or standard deviation of this distribution measures the size of the body of the distribution. The HVaR margin is some tail percentile of this distribution. While neither desiring to be bound by any particular theory nor intending to limit in any measure the scope of the appended claims or their equivalents, it is presently believed that shrinking the body of the distribution should reduce the tail. To verify this intuition, an exemplary portfolio of futures was reviewed and standard deviations were calculated from the HVaR scenario distribution and the HVaR margin for varying allocations of positions. As shown in FIG. 7, standard deviation and margin have a very strong relationship.

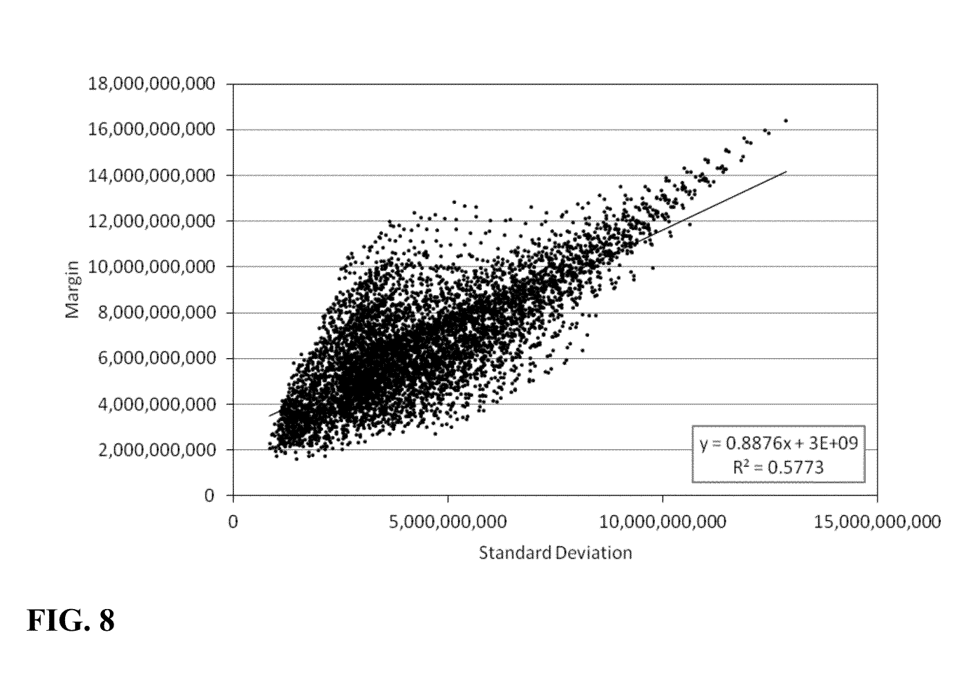

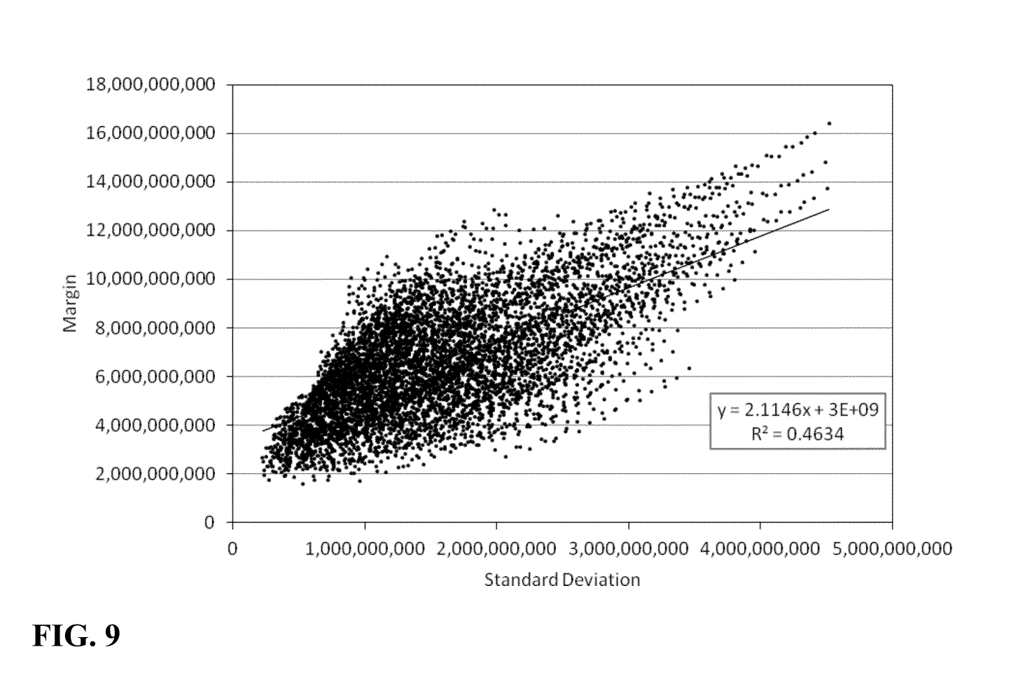

The other half of the problem is to minimize the SPAN margin. The SPAN margin algorithm calculates margin based on a wide array of inputs for each product, based on several metrics related to price changes, as well as recent volatility. These inputs and portfolio are then sent through a sequence of steps to calculate the margin, where explicit correlation offsets between products are controlled through parameters set by Risk Managers. Given the fairly involved and partly non-parametric nature of this process, some embodiments approximate the SPAN methodology using a scenario-based margin algorithm. To compare the various scenario sets, an exemplary portfolio of futures was reviewed and the standard deviation was calculated from the portfolio change distribution and the SPAN margin for varying allocations of positions. As shown in FIGS. 8 and 9, the HVaR scenarios are the most correlated with SPAN margins. In some embodiments, due to the 5-day to 1-day discrepancy between HVaR scenarios and SPAN margins, the scenarios should be scaled down. It will be appreciated that a better scenario set may be developed to represent SPAN margins and that all such improved sets are contemplated for use herein.

In some embodiments, an objective of optimization tool in accordance with the present teachings is to reduce the sum of the HVaR margin for the OTC account and the SPAN margin for the SEG account. This sum represents the total margin due to the Clearing House.

M_{T}=M_{O}+M_{S},
where M_{T} is the total margin,
   M_{O} is the OTC margin, and
   M_{S} is the SEG margin.

Given that margin is proportional to standard deviation, the value to consider is the sum of the standard deviations.

σ_{T}=σ_{O}+σ_{S},

≠\sqrt{σ_{O}²+σ_{S}²}
where σ_{T} is the total margin,
   σ_{O} is the OTC margin, and
   σ_{S} is the SEG margin.

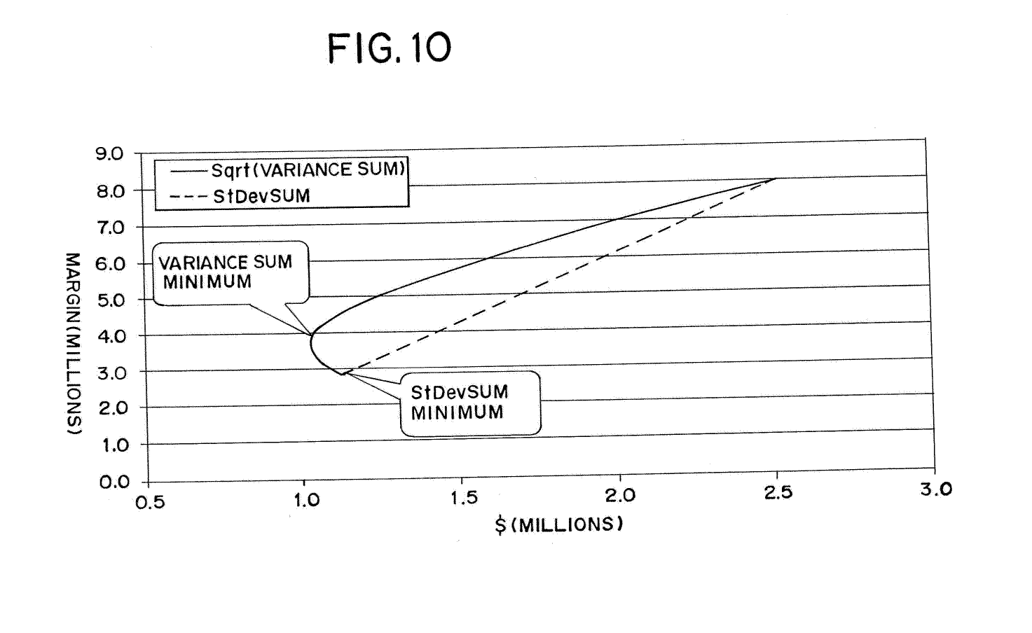

Note that this value is not equal to the square root of the sum of variances. Typically, this expression is seen as the standard deviation of the sum of two uncorrelated random variables, which is quite different from the problem at hand. FIG. 10 shows a portfolio of one future position and a small swaps position. As can be seen from FIG. 10, minimizing the variance sum may not result in the minimum total margin.

Typically, to generate the scenario portfolio change distribution in the HVaR margin methodology, the scenario data is calculated first, and then the portfolio is priced on each scenario datum separately. This can be an expensive procedure especially as the number of positions grows. Due to the speed and distributed computation design requirements, a sensitivity-based approximation was used to calculate the scenario portfolio change distribution. This choice does introduce some error in the optimization algorithm but is not expected to significantly alter the solution.

A review of the manner in which scenario changes are computed in the HVaR margin methodology can illustrate the scenario portfolio change approximation. The superscript ^{S} represents scenario S and superscript ^{B} represents today's data.

$$\begin{matrix}Δ {P}^{S} = {\sum }_{c ∈ C} {P}_{c}^{S} {X}_{c}^{S} - {P}_{c}^{B} {X}_{c}^{B} \\ = {\sum }_{c ∈ C} ( {P}_{c}^{S} - {P}_{c}^{B} ) {X}_{c}^{S} + {\sum }_{c ∈ C} ( {X}_{c}^{S} - {X}_{c}^{B} ) {P}_{c}^{B} \\ \approx {\sum }_{c ∈ C} ( {P}_{c}^{S} - {P}_{c}^{B} ) {X}_{c}^{S}\end{matrix}$$

where P is the IRS NPV,
   X is the FX rate to USD, and
   C is the set of all currencies.

The FX risk term is ignored under the assumption that FX scenario changes tend to be small and portfolios are close to par.

The local currency portfolio change term is approximated by a first-order sensitivity. Given a currency,

$${P}^{S} - {P}^{B} = {\sum }_{t ∈ T} \frac{\partial P}{\partial {r}_{t}} ( {r}_{t}^{S} - {r}_{t}^{B} ) + {( {r}_{t}^{S} - {r}_{t}^{B} )}^{2}$$

where P is the IRS NPV,
   r is the zero rate, and
   T is the set of all tenors.

The SPAN margin methodology offers significant netting benefits between offsetting futures and options positions. In some embodiments of the algorithm, this is done on a delta basis where delta is the price sensitivity to the underlying future. In some embodiments, the option's delta can be calculated according to the Black-Schole's formula with one day of time-decay. This delta is referred to as the composite delta. In the optimization algorithm, one options position is treated as composite delta positions in the underlying future. These Futures' equivalents are treated as futures that cannot be moved from the SEG account.

Given that the optimization algorithm makes approximations to margins, it can sometimes happen that the solution from the algorithm can actually increase total margin. To safeguard against this possibility, a final step of the algorithm is to validate that the total margin has actually decreased.

This check compares prior IRS and portfolio-margined futures HVaR margin plus remaining futures and options SPAN margin to optimized IRS and portfolio-margined futures HVaR margin plus optimized remaining futures:

HVaR(IRS+Prior Futures)+SPAN(Prior Remaining Futures+Options)>HVaR(IRS+Optimized Futures)+SPAN(Optimized Remaining Futures+Options)

In the above equation, the IRS HVaR margin is based on the approximated scenario IRS changes. Due to the potential for error even with the margin check, it is desirable that the total margin decrease by a set threshold.

In some embodiments, algorithm formulation can be achieved as described below:

```
Setup
Consider a random variable which represents the scenario changes in the
portfolio value of the OTC account.
      P_{OTC} = Z₁ + p₂Z₂ + . . . + pₙZₙ
          = Z1 + \vec{p}^{T}\vec{Z₂ₙ}
      where Z₁ is the swaps portfolio P/L,
          pᵢ, i ε {2, . . . , n} is the net position in Future i, and
          Zᵢ, i ε {2, . . . , n} is the Future i P/L.
Now the variance of this random variable is computed.
      $\begin{matrix}t ( {p}^{->} ) ≡ Var ( {P}_{OTC} ) = 𝔼 ( {Z}_{1} + {{p}^{->}}^{T} {{Z}_{2 n}}^{->} ) {( {Z}_{1} + {{p}^{->}}^{T} {{Z}_{2 n}}^{->} )}^{T} \\ = {\sum }_{11} + 2 {{{\sum }_{21}}^{->}}^{T} {p}^{->} + {{p}^{->}}^{T} {\sum }_{22} {p}^{->}\end{matrix}$
          where Σ₁₁ is the swaps variance,
              Σ₂₁ is the swaps/Furtures covariance, and
              Σ₂₂ is the OTC Futures covariance.
The same procedure gives the variance of the SEG account.
$\begin{matrix}s ( {p}^{->} ) ≡ Var ( {P}_{SEG} ) = 𝔼 ( {( {o}^{->} + {T}^{->} - {p}^{->} )}^{T} Y ) {( {( {o}^{->} + {T}^{->} - {p}^{->} )}^{T} Y )}^{T} \\ = {( {o}^{->} + {T}^{->} - {p}^{->} )}^{T} {\sum }_{Y} ( {o}^{->} + {T}^{->} - {p}^{->} )\end{matrix}$
        where \vec{o} are the Options Futures equivalent position,
          \vec{T} = \vec{L} − \vec{S} are the total net position of the Futures, and
          Σ_{Y} is the SEG Futures covariance.
Now, the objective function is defined as the weighted sum of the standard
deviations.
        $\begin{matrix}f ( {p}^{->} ) = α \sqrt{Var ( {P}_{OTC} )} + ( 1 - α ) \sqrt{Var ( {P}_{SEG} )} \\ = α \sqrt{t ( {p}^{->} )} + ( 1 - α ) \sqrt{s ( {p}^{->} )}\end{matrix}$
Note that position allocation variable controls the positions in the OTC
account. The objective function should be minimized with the constraint
that the allocated position does not exceed the available longs or shorts.
              −\vec{S} ≦ \vec{p} ≦ \vec{L}
            where \vec{S} are the shorts and
              \vec{L} are the longs.
The OTC variance and covariance matrices are estimated from HVaR
margin scenarios. As discussed previously, the SEG covariance is also
estimated from HVaR margin scenarios. Because of the coverage horizon
mismatch, the weighting variable is used to scale down the SEG standard
deviation The weighting parameter is chosen so that the ratio of weights is
\sqrt{c}.
            $\begin{matrix}{\sum }_{Y} = {\sum }_{22} \\ α = \frac{1}{1 + \sqrt{c}}\end{matrix}$
          where c is a HVaR-SPAN coefficient.
Taking the objective function and bounds together gives a non-linear
programming problem. To assist in solving this problem, the gradient
vector and Hessian matrix are needed.
        $∇ f ( {p}^{->} ) = α \frac{{{\sum }_{21}}^{->} + {\sum }_{22} {p}^{->}}{\sqrt{t ( {p}^{->} )}} + ( 1 - α ) \frac{{\sum }_{Y} ( {p}^{->} - {T}^{->} - {o}^{->} )}{\sqrt{s ( {p}^{->} )}}$
    $H = α \frac{{\sum }_{22}}{\sqrt{t ( {p}^{->} )}} - α \frac{( {{\sum }_{21}}^{->} + {\sum }_{22} {p}^{->} ) {( {{\sum }_{21}}^{->} + {\sum }_{22} {p}^{->} )}^{T}}{{t ( {p}^{->} )}^{\frac{3}{2}}} +$
      $( 1 - α ) \frac{{\sum }_{Y}}{\sqrt{s ( {p}^{->} )}} - ( 1 - α ) \frac{( {\sum }_{Y} ( {p}^{->} - {T}^{->} - {o}^{->} ) ) {( {\sum }_{Y} ( {p}^{->} - {T}^{->} - {o}^{->} ) )}^{T}}{{s ( {p}^{->} )}^{\frac{3}{2}}}$
In the optimization implementation, the non-linear program is solved using
the interior point method as implemented by the IPOPT library.
```

IPOPT (Interior Point OPTimizer) is a software package for large-scale nonlinear optimization. Additional information regarding IPOPT is available from the IPOPT home page on the internet (https://projects.coin-or.org/Ipopt/) and the literature (e.g., Wachter, Andreas; and Biegler, Lorenz. “On the Implementation of an Interior-Point Filter Line-Search Algorithm for Large-Scale Nonlinear Programming,” Mathematical Programming, 2006, 25-27). It is designed to find (local) solutions of mathematical optimization problems of the form:

min f(x)

x in R̂n

s.t. g_{—}L<=g(x)<=g_{—}U

x_{—}L<=x<=x_{—}U

where f(x): R̂n→R is the objective function, and g(x): R̂n→R̂m are the constraint functions. The vectors g_L and g_U denote the lower and upper bounds on the constraints, and the vectors x_L and x_U are the bounds on the variables x. The functions f(x) and g(x) can be nonlinear and nonconvex, but should be twice continuously differentiable. Note that equality constraints can be formulated in the above formulation by setting the corresponding components of g_L and g_U to the same value.

In one exemplary test of the optimization tool described above to test the performance, accuracy, and robustness of the optimization algorithm, the results from 1,688 portfolios were analyzed.

To ensure that all aspects of the algorithm were tested, portfolios that covered the universe of potential portfolios were created. With this goal in mind, available client portfolios were sampled, and portfolios targeting specific strategies were generated and the set filled out by creating portfolios of random futures and IRS. To summarize this set, the portfolios were grouped into their type and by the number of trades, as shown in Tables 6 and 7, respectively.

TABLE 6

| Portfolio Type | # of Portfolios | Percentage |
|---|---|---|
| Client | 122 | 7% |
| Client + Synthetic | 516 | 31% |
| Targeted | 50 | 3% |
| Random | 1,000 | 59% |
| Grand Total | 1,688 | 100% |

TABLE 7

| No. of Trades | No Futures | 1 Future | Many Futures | Grand Total |
|---|---|---|---|---|
| No IRS | 2* | 2 | 15 | 19 |
| 1 IRS | 8 | 12 | 12 | 32 |
| Many IRS | 0 | 0 | 1,637 | 1,637 |
| Grand Total | 10 | 14 | 1,664 | 1,688 |

*The 2 no futures and no IRS portfolios have offsetting futures positions.

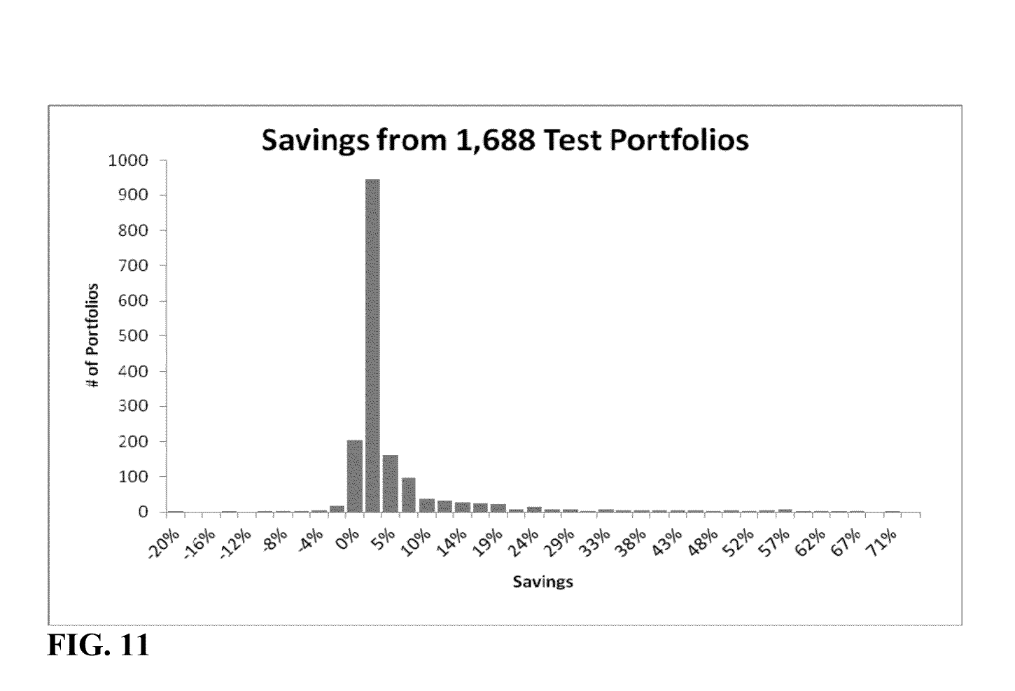

To examine margin reduction for the sample portfolios, savings is defined as the percent decrease in total margin. Total margin is the sum of the HVaR margin for the OTC account and SPAN margin for the SEG account. The histogram shown in FIG. 11 shows the margin savings for all 1,688 portfolios. The results indicate 92% of portfolios have 0 or positive savings, and 8% of portfolios have negative savings. In some cases, 0 savings is considered to be a success because targeted portfolios were created where no positions should be moved. Some examples include futures-only portfolios, IRS-only portfolios, and IRS and Futures portfolios in the same direction.

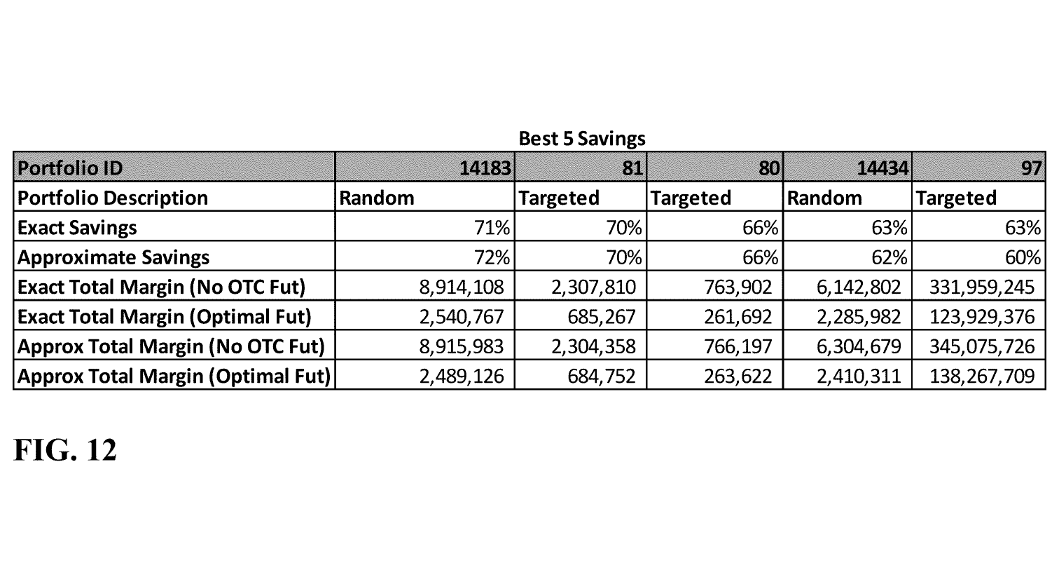

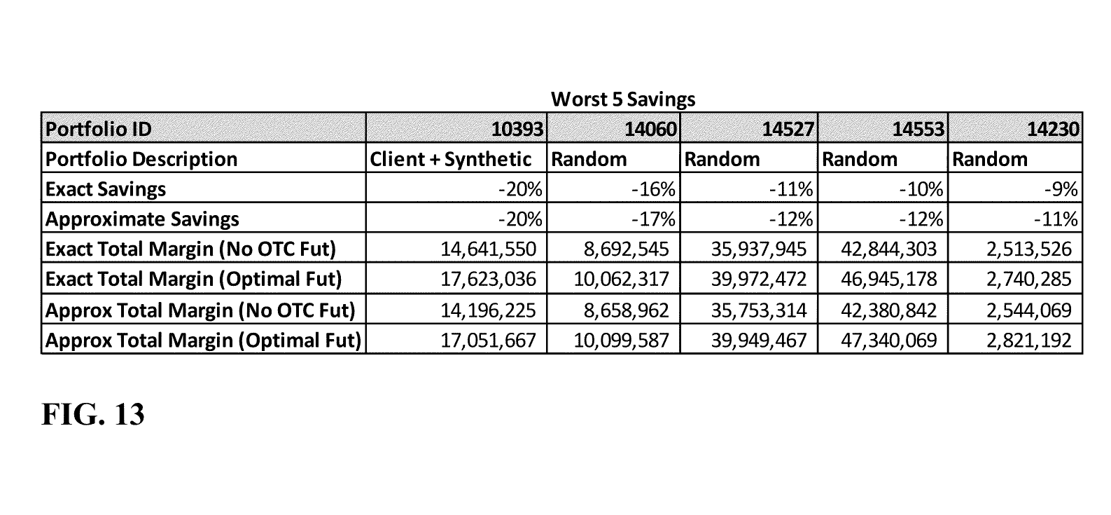

In the tables shown in FIGS. 12 and 13, ten portfolios with the 5 best and 5 worst savings are summarized. With respect to the 5 best savings, the contents of these 5 portfolios are as follows:

14183—Random IRS vs. Random Futures

81—5 yr ATM IRS vs. 5 yr ED Strip

80—2 yr ATM IRS vs. 2 yr ED Strip

14434—Random IRS vs. Random Futures

97—Client IRS Book vs. ED Hedge

With respect to the 5 worst savings, note that Total Margin=HVar margin+SPAN margin. Exact margin is based on the exact IRS scenario PnL, whereas approximate margin is based on the scenario PnL from the delta ladder approximation. The contents of these 5 portfolios are as follows:

10393—Client IRS Book vs. Different Client Futures Book

14060—Random IRS vs. Random Futures

14527—Random IRS vs. Random Futures

14553—Random IRS vs. Random Futures

14230—Random IRS vs. Random Futures

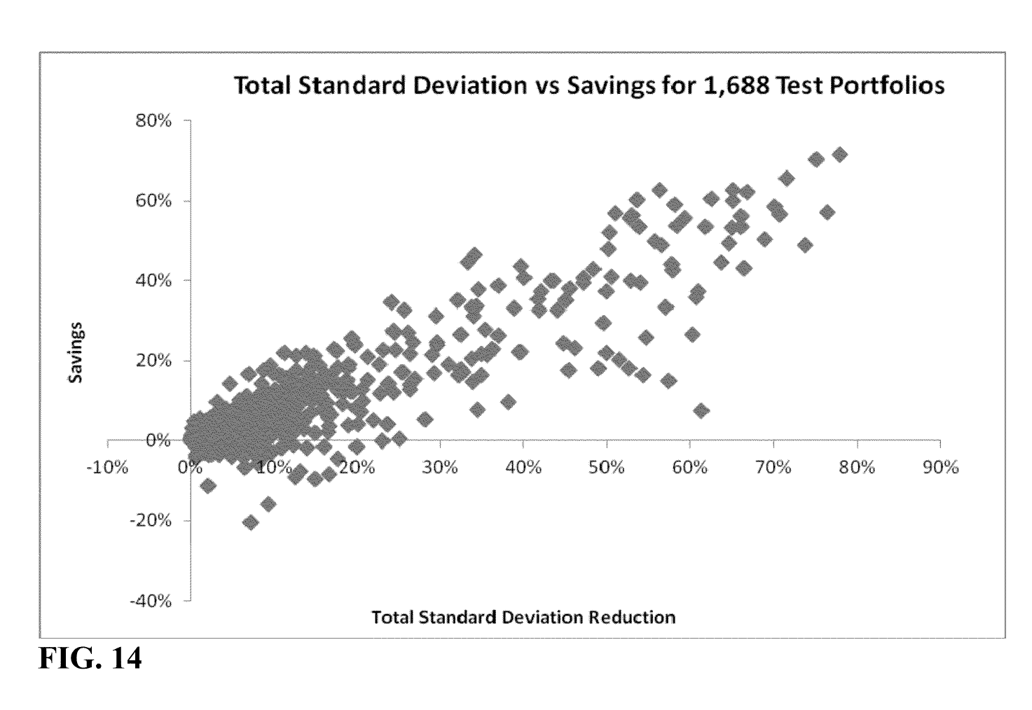

In some embodiments, the optimization tool is based on the assumption that minimizing the total standard deviation will maximize the savings. This assumption was tested by comparing the reduction in total standard deviation to the reduction in margin. Total standard deviation is defined as the sum of OTC standard deviation and SEG standard deviation. As shown in FIG. 14, the two quantities do indeed have a positive relationship. However, the relationship is not strict as sometimes reducing total standard deviation can lead to small increases in margin. Since, in some embodiments, the optimization algorithm will reduce standard deviation, the percentage of cases where the standard deviation and margin relationship breaks down is equal to the percentage of negative savings (i.e., 8% as may be seen in FIG. 14).

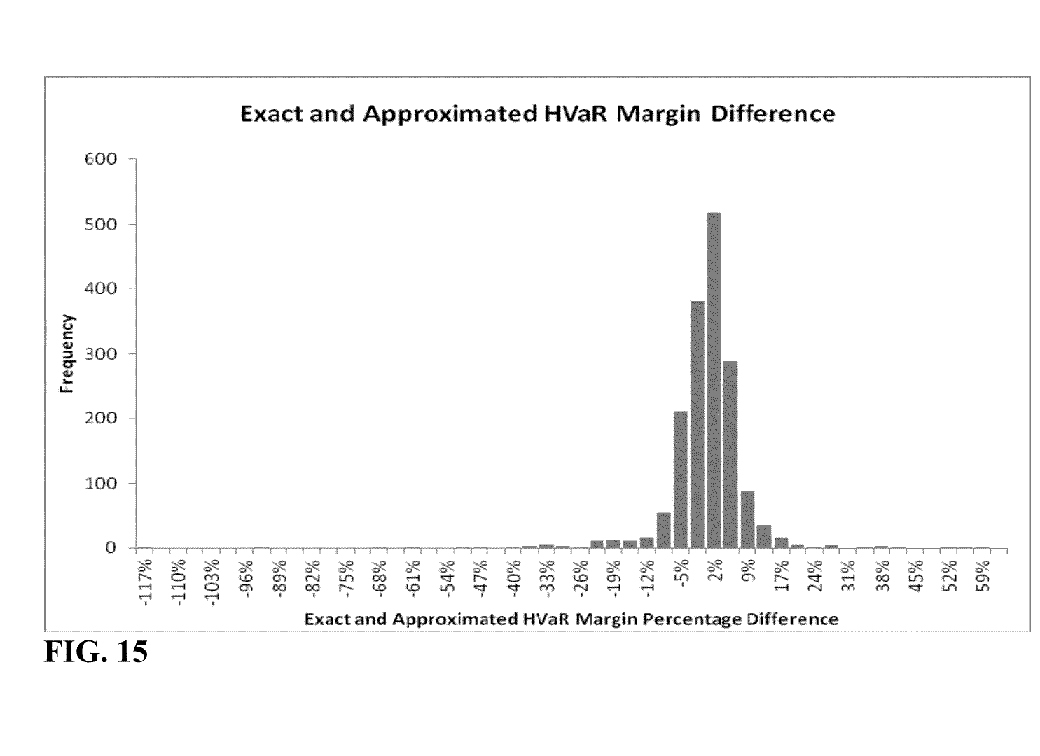

In some embodiments, the optimization tool uses a delta ladder approximation for the IRS positions to calculate the HVaR Margin. To examine the error of this approximation, the percentage difference between the exact HVaR IRS margin and the approximate HVaR IRS margin was calculated using the delta ladder. A histogram of these differences is provided in FIG. 15, which shows that 91% of portfolios have less than 10% difference between the exact HVaR margin and the delta ladder approximation.

To confirm that the options delta approximation is accurate, the optimized total margins were compared with and without composite delta approximation for the options. Using the composite options delta approximation produces lower total margin as shown in Table 8.

TABLE 8

| Total Margin (millions) | Portfolio 1* | Portfolio 2** |
|---|---|---|
| No OTC Futures | 11.9 | 30.0 |
| No Option Delta | 13.4 | 27.0 |
| Approximation | | |
| With Option Delta | 12.0 | 22.8 |
| Approximation | | |

*Portfolio 1: 2012 September delta hedged 2 yr Treasury note options and futures, and PV01 hedged 10 yr swap
**Portfolio2: 2012 September delta hedged 10 yr Treasury note options and futures, and PV01 hedged 20 yr swap

In some embodiments, it is desirable that the optimization tool algorithm should not be overly dependent on specific portfolio characteristics or specific parameter values so that that the algorithm can produce reasonable results regardless of environment. To test robustness, an attempt was made to cover all possible portfolio characteristics in the sample set and the optimization tool was executed for varying parameter values.

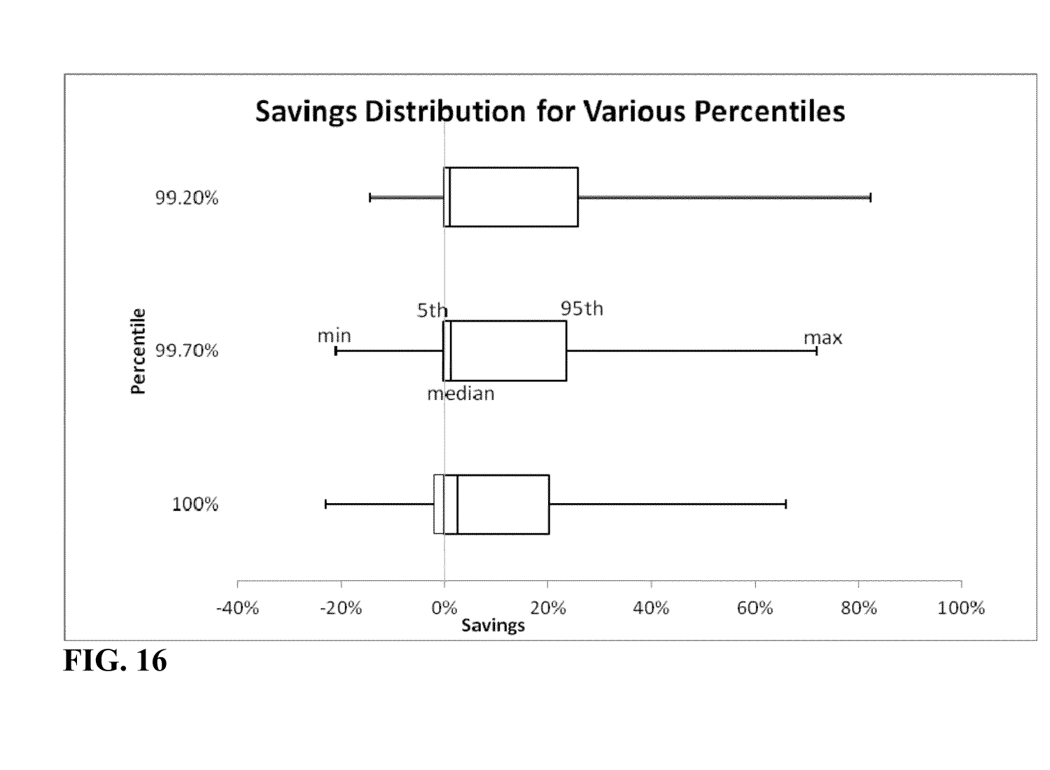

With respect to percentile sensitivity, first the percentile for the HVaR margin was varied. The boxes in the chart shown in FIG. 16 represent 90% of the portfolios. The savings are not drastically different in the different cases. However, the savings distributions do not shift slightly higher as the percentile decreases. While neither desiring to be bound by any particular theory nor intending to limit in any measure the scope of the appended claims or their equivalents, it is presently believed that this observation suggests that at lower percentiles, standard deviation and margin are more closely related.

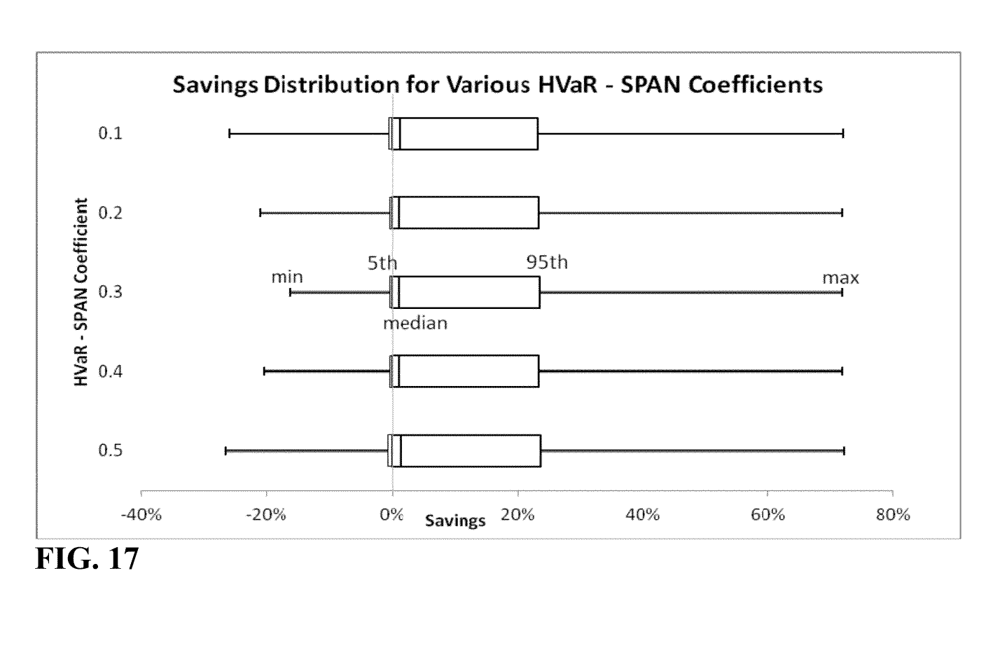

With respect to HVaR-SPAN coefficient sensitivity, the savings distribution for different values of the HVaR-SPAN coefficient was reviewed. Again, the savings distribution is fairly similar with different coefficient values, with the coefficient value of 0.3 having the lowest minimum savings. Moreover, by comparing the 5th percentile, median, and 95th percentile data shown in Table 9 and FIG. 17, it is seen that the 0.3 coefficient value has the best savings distribution.

TABLE 9

| | HVaR-SPAN Coefficients | | | | |
|---|---|---|---|---|---|
| | 0.1 | 0.2 | 0.3 | 0.4 | 0.5 |
| 5th | −0.57% | −0.40% | −0.38% | −0.41% | −0.65% |
| percentile | | | | | |
| Median | 0.67% | 0.70% | 0.72% | 0.71% | 0.70% |
| 95th | 22.73% | 23.02% | 23.29% | 22.99% | 23.13% |
| percentile | | | | | |

To make sure that an optimization tool routine in accordance with the present teachings is capable of handling a large number of variables, three portfolios with all 62 listed interest rate futures contracts were produced. The optimization still successfully terminated and the portfolios showed some savings. However, there was a slight increase in the number of iterations, as shown in Table 10.

TABLE 10

| Portfolio ID | 200 | 201 | 202 |
|---|---|---|---|
| Portfolio | Client + Synthetic | Client + Synthetic | Targeted |
| Description | | | |
| Exact Savings | 6% | 5% | 43% |
| Approximate | 6% | 5% | 40% |
| Savings | | | |
| Exact Total | 4,417,953 | 140,138,406 | 22,506,444 |
| Margin (No OTC | | | |
| Fut) | | | |
| Exact Total | 4,144,977 | 133,630,636 | 12,805,928 |
| Margin (Optimal | | | |
| Fut) | | | |
| IPOpt Number | 16 | 17 | 18 |
| Iterations | | | |

The contents of the 3 above-described portfolios are as follows:

200—Client IRS Book vs. All 62 listed Interest Rate Futures Contracts

201—Client IRS Book vs. All 62 listed Interest Rate Futures Contracts

202—2 yr, 5 yr, 10 yr, 30 yr ATM IRS vs. All 62 listed Interest Rate Futures Contracts

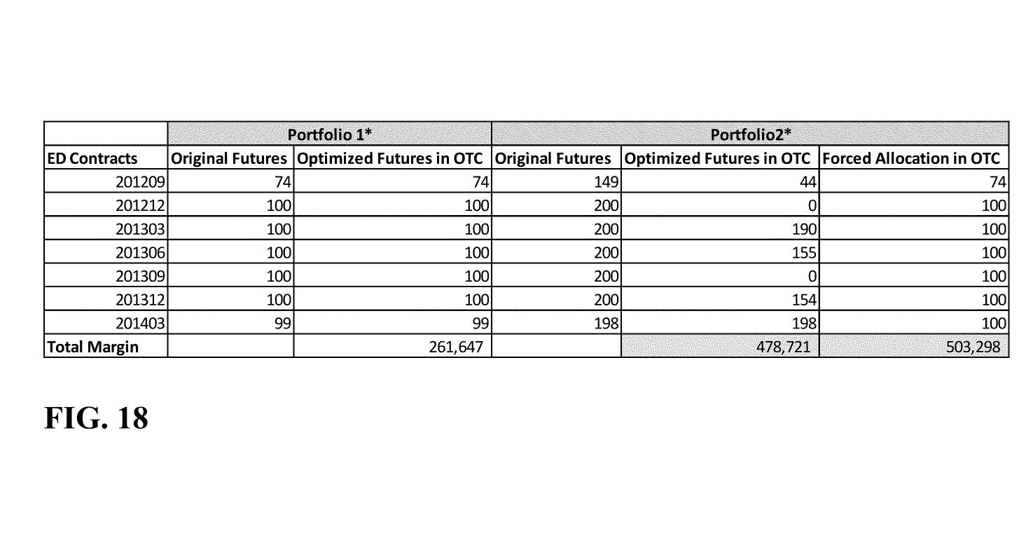

In addition, some exemplary portfolios were generated to contain one “at the money” (ATM) IRS with doubled optimal ED hedge. The optimization tool didn't move half of each ED with IRS but, as shown by the table in FIG. 18, it obtained a better result. This shows that it is not necessarily true that the “optimized” results should move half of the doubled ED positions. With respect to FIG. 18, Portfolio 1 contains 2 yr ATM swap and 2 yr ED strip, and Portfolio 2 contains 2 yr ATM swap and doubled 2 yr ED strip.

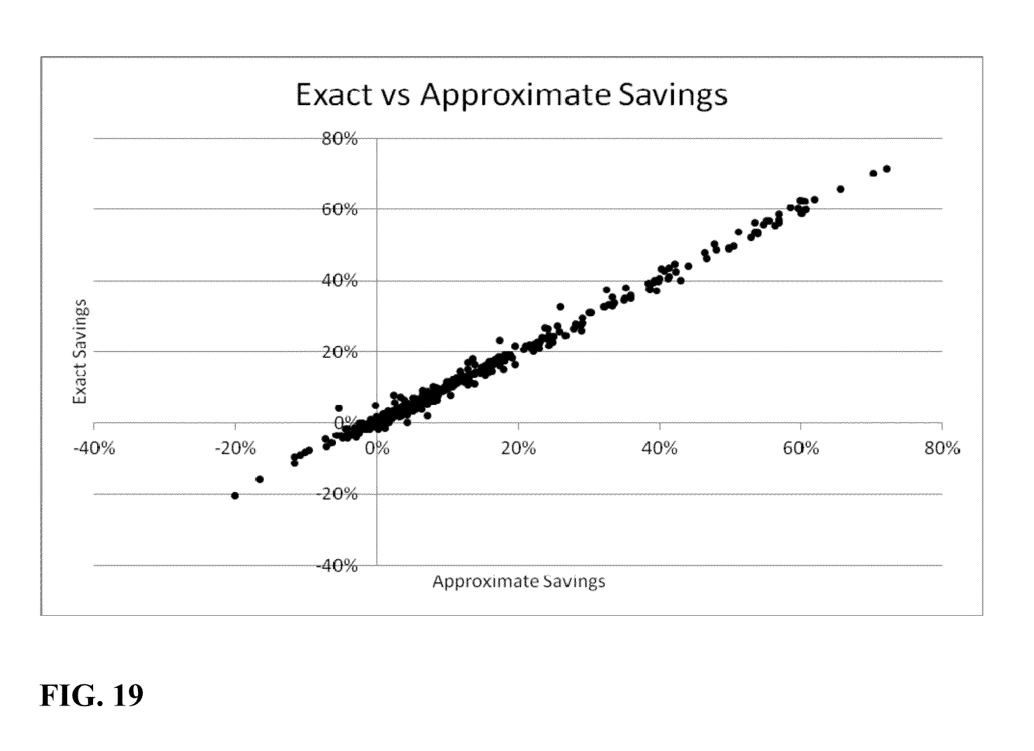

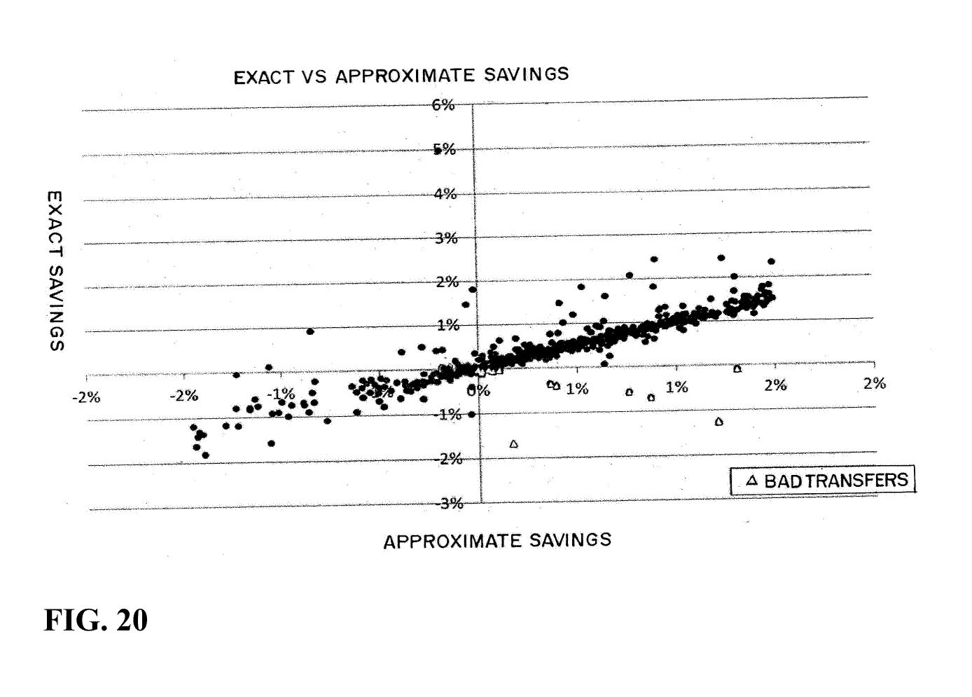

Confirmation is obtained that the delta ladder approximation savings guarantees exact savings (i.e., positive approximate savings results in positive exact savings; the case of negative approximate savings is not considered for position move). Out of 1688 portfolios, there were 16 cases in which there were positive approximate savings and negative exact savings, with the largest saving within these 16 cases being 1.3%. Taking this as the minimum threshold for approximate savings to guarantee exact savings, it is observed that 40% of the 1688 portfolios have approximate savings above the threshold, as shown in FIGS. 19 and 20.

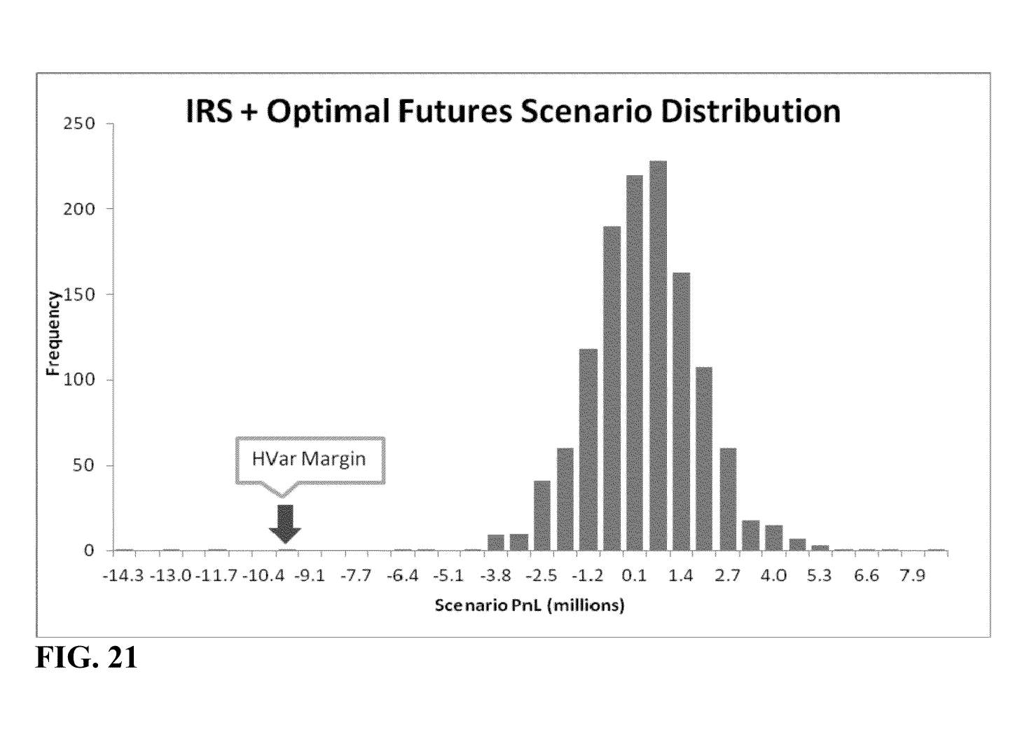

Five portfolios have bad savings because their PnL distribution has long left tails. This shows that if the PnL distribution is not “normal” enough, it will not work well in the optimization tool, as shown in FIG. 21.

While some embodiments may be described with reference to their applicability to electronic trading systems that trade OTC contracts, futures contracts, and/or derivatives thereof, it will be appreciated that they may applicable to any electronic trading system including but not limited to systems that trade derivatives, equities, and/or other products.

It will be appreciated that a trading environment, such as a futures exchange as described herein, implements one or more economic markets where rights and obligations may be traded. As such, a trading environment may be characterized by the need to maintain market integrity, transparency, predictability, fair/equitable access, and participant expectations with respect thereto. By way of example, in some embodiments, an exchange responds to inputs (e.g., trader orders, cancellations, and the like) in a manner expected by the market participants, such as based on market data (e.g. prices), available counter-orders, and the like, to provide an expected level of certainty that transactions will occur in a consistent and predictable manner and without unknown or unascertainable risks. In addition, it will be appreciated that in some embodiments, electronic trading systems may further impose additional expectations and demands from market participants as to transaction processing speed, latency, capacity and response time, while creating additional complexities relating thereto. Accordingly, as will be described, some embodiments may further include functionality to ensure that the expectations of market participants are met (e.g., that transactional integrity and predictable system responses are maintained).

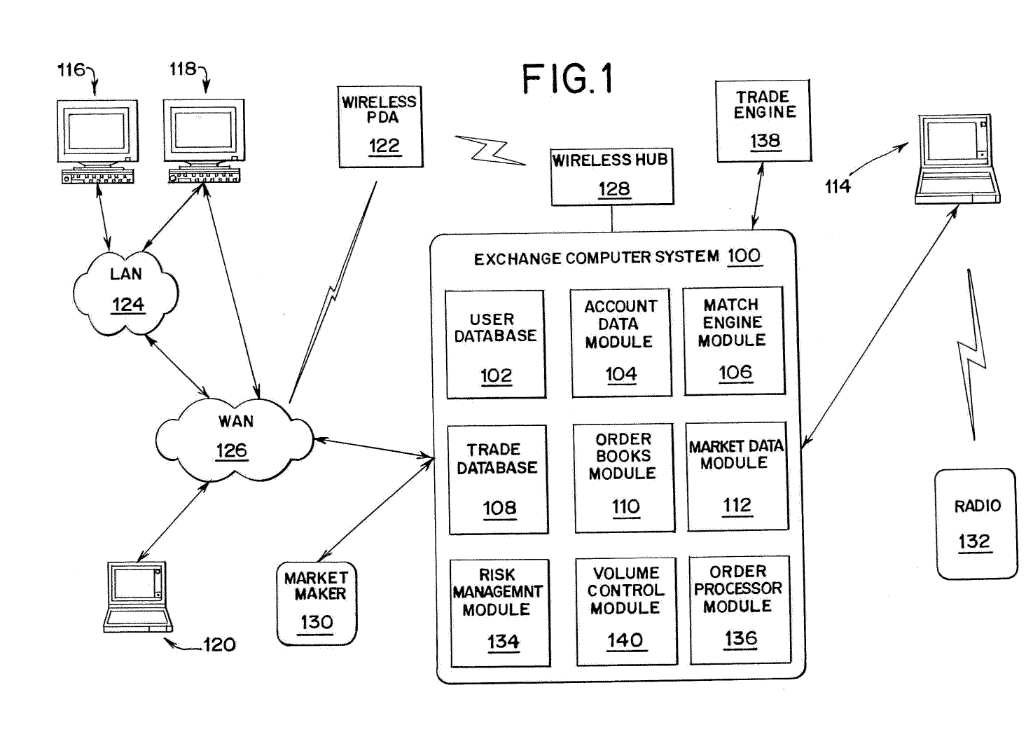

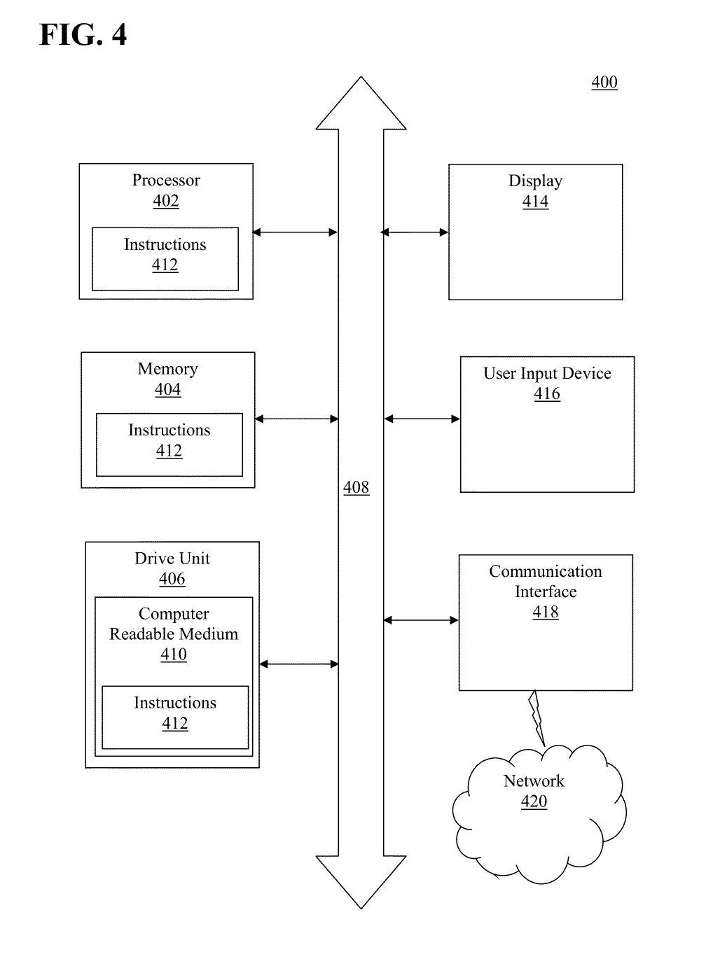

In some embodiments, systems and methods are disclosed for reducing, minimizing or otherwise optimizing a margin requirement across accounts such as OTC IRS and IR futures accounts. Some embodiments are desirably implemented with computer devices and computer networks, such as those shown in FIG. 4 and described below, which allow users (e.g., market participants) to access exchange trading information. It will be appreciated that the plurality of entities utilizing embodiments in accordance with the present teachings (e.g., the market participants) may be referred to by other nomenclature reflecting the role that the particular entity is performing with respect to a particular embodiment, and that a given entity may perform more than one role depending upon the implementation and the nature of the particular transaction being undertaken, as well as the entity's contractual and/or legal relationship with other market participants and/or the Exchange. An exemplary trading network environment for implementing trading systems and methods is shown in FIG. 1. An exchange computer system 100 receives orders and transmits market data related to orders and trades to users, such as via computer devices 114, 116, 118, 120, and 122, as further described below, coupled with the exchange computer system 100. In some embodiments, the exchange 100 includes a place or system that receives and/or executes orders for traded products.

As used herein, the phrase “coupled with” is defined to mean directly connected to or indirectly connected through one or more intermediate components. Such intermediate components may include both hardware and/or software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions here before or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The exchange computer system 100 may be implemented with one or more mainframe, desktop, and/or other computers, including but not limited to the computer 400 described below with respect to FIG. 4. In some embodiments, a user database 102 may be provided which includes information identifying traders and other users of exchange computer system 100, such as account numbers or identifiers, user names, passwords, or the like, and combinations thereof. In some embodiments, an account data module 104 may be provided which can process account information that may be used during trades. In some embodiments, a match engine module 106 may be included to match bid and offer prices and may be implemented with software that executes one or more algorithms for matching bids and offers. In some embodiments, a trade database 108 may be included to store information identifying trades and descriptions of trades. In particular, a trade database may store information identifying the time that a trade took place and the contract price. In some embodiments, an order book module 110 may be included to compute or otherwise determine current bid and offer prices for one or more products. In some embodiments, a market data module 112 may be included to collect market data and prepare the data for transmission to users. In some embodiments, a risk management module 134 may be included to compute and determine a user's risk utilization in relation to the user's defined risk thresholds. In some embodiments, an order processing module 136 may be included to decompose delta based and bulk order types for processing by the order book module 110 and/or match engine module 106. A volume control module 140 may be included to, among other things, control the rate of acceptance of mass quote messages.

As shown in FIG. 1, the trading network environment, in some embodiments, includes exemplary computer devices 114, 116, 118, 120, and 122, which depict different exemplary methods and/or media by which a computer device may be coupled with the exchange computer system 100 or by which a user may communicate (e.g., send, receive, and/or trade information) therewith. It will be appreciated that the types of computer devices deployed by traders and the methods and media by which they communicate with the exchange computer system 100 is implementation dependent and may vary, and that not all of the depicted computer devices and/or means/media of communication may be used and that other computer devices and/or means/media of communications—now available or later developed—may be used. In some embodiments, each computer device 114, 116, 118, 120, and 122, which may comprise a computer 400 described in more detail below with respect to FIG. 4, may include a central processor that controls the overall operation of the computer and a system bus that connects the central processor to one or more conventional components, such as a network card or modem. In some embodiments, each computer device 114, 116, 118, 120, and 122 may also include a variety of interface units and drives for reading and writing data or files and communicating with other computer devices and with the exchange computer system 100. Depending on the type of computer device 114, 116, 118, 120, and 122, a user can interact with the computer with a keyboard, pointing device, touch interface, microphone, pen device or other input device now available or later developed.

An exemplary computer device 114 is shown directly connected to exchange computer system 100, such as via a T1 line, a common local area network (LAN), and/or other wired and/or wireless media for connecting computer devices. The exemplary computer device 114 is further shown connected to a radio 132. The user of radio 132, which may include a cellular telephone, smart phone, or other wireless proprietary and/or non-proprietary device, may be a trader or exchange employee. In some embodiments, the radio user may transmit orders or other information to the exemplary computer device 114 or a user thereof. The user of the exemplary computer device 114, or the exemplary computer device 114 alone and/or autonomously, may then transmit the trade or other information to the exchange computer system 100.

In some embodiments, exemplary computer devices 116 and 118 are coupled with a LAN 124 which may be configured in one or more of the well-known LAN topologies (e.g. star, daisy chain, and the like) and may use a variety of different protocols including but not limited to an Ethernet, TCP/IP, or the like, and combinations thereof. In some embodiments, the exemplary computer devices 116 and 118 may communicate with each other and with other computer and other devices that are coupled with the LAN 124. Computers and other devices may be coupled with the LAN 124 via twisted pair wires, coaxial cable, fiber optics, other wired or wireless media, or the like, and combinations thereof. As shown in FIG. 1, an exemplary wireless personal digital assistant device (PDA) 122—such as a mobile telephone, tablet-based computer device, or other wireless device—may communicate with the LAN 124 and/or the Internet 126 via radio waves (e.g., via WiFi, Bluetooth and/or a cellular telephone based data communications protocol). PDA 122 may also communicate with exchange computer system 100 via a conventional wireless hub 128.

FIG. 1 also shows the LAN 124 coupled with a wide area network (WAN) 126 which may be comprised of one or more public or private wired or wireless networks. In some embodiments, the WAN 126 includes the Internet 126. In some embodiments, the LAN 124 may include a router to connect LAN 124 to the Internet 126. An exemplary computer device 120 is shown coupled directly to the Internet 126, such as via a modem, DSL line, satellite dish or any other device for connecting a computer device to the Internet 126 via a service provider.

In some embodiments, the users of the exchange computer system 100 may include one or more market makers 130, which may maintain a market by providing constant bid and offer prices for a derivative or security to the exchange computer system 100, such as via one of the exemplary computer devices depicted. In some embodiments, the exchange computer system 100 may also exchange information with other trade engines, such as trade engine 138. One skilled in the art will appreciate that in some embodiments, numerous additional computers and systems may be coupled to exchange computer system 100. Such computers and systems may include but are not limited to clearing, regulatory, and fee systems, or the like, and combinations thereof.

In some embodiments, the operations of computer devices and systems such as those shown in FIG. 1 may be controlled by computer-executable instructions stored on a non-transitory computer-readable medium. By way of example, in some embodiments, the exemplary computer device 116 may include computer-executable instructions for receiving order information from a user and transmitting that order information to exchange computer system 100. In some embodiments, the exemplary computer device 118 may include computer-executable instructions for receiving market data from exchange computer system 100 and displaying that information to a user.

Of course, in some embodiments, numerous additional servers, computers, handheld devices, personal digital assistants, telephones and other devices may also be connected to exchange computer system 100. Moreover, one skilled in the art will appreciate that the topology shown in FIG. 1 is merely representative, and that the components shown in FIG. 1 may include other components not shown and/or be connected by numerous alternative topologies.

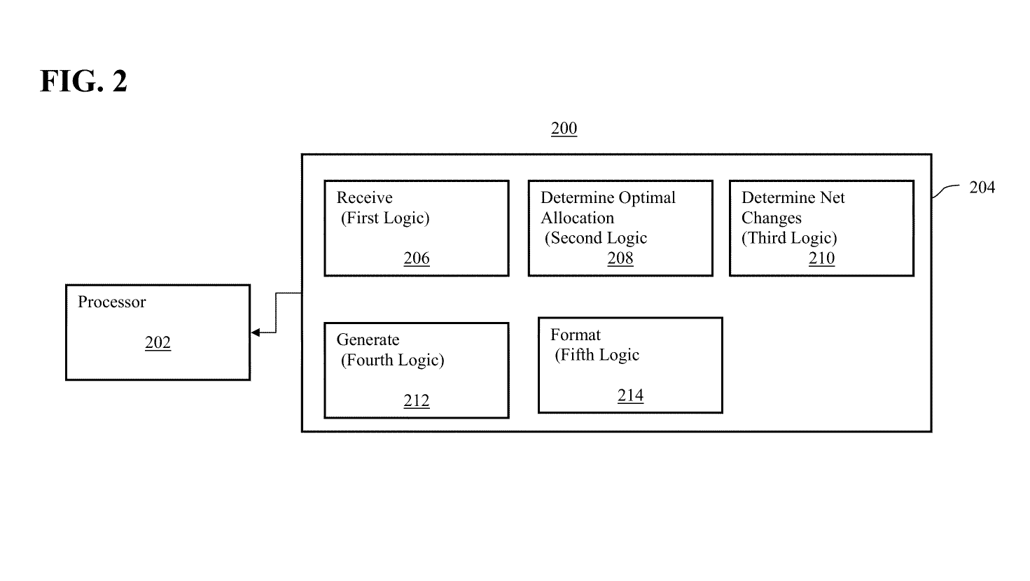

As further described below in reference to FIG. 2, some embodiments in accordance with the present teachings may be implemented as part of a risk management module 134. However, it will be appreciated that the mechanisms described herein may be implemented at any logical and/or physical point(s), or combinations thereof, at which the relevant data may be monitored or is otherwise accessible and/or measurable, including but not limited to in one or more gateway devices, modems, computers and/or terminals of one or more traders or the like.

FIG. 2 depicts a block diagram of a representative system 200 for minimizing a margin requirement of a trader holding first and second accounts (e.g., an IR futures account and an OTC IRS account), the first and second accounts being characterized by a combined margin requirement which, in an exemplary implementation, is implemented as part of the risk management module 134 of the exchange computer system 100 described above.

In some embodiments, the system 200 includes a processor 202 and a memory 204 coupled therewith, which may be implemented as a processor 402 and memory 404 as described below with respect to FIG. 4. In some embodiments, the system 200 further includes first logic 206 stored in the memory 204 and executable by the processor 202 to cause the processor 202 to receive data representative of a first plurality of positions in the first account and a second plurality of positions in the second account. In some embodiments, the system 200 may be coupled to other modules of the exchange computer system 100 so as to have access to the relevant parameters as described herein and initiate the requisite actions as further described below.

In some embodiments, the system 200 further includes second logic 208 stored in the memory 204 and executable by the processor 202 to cause the processor 202 to determine an optimal reallocation of the first and second plurality of positions between the first and second accounts which results in a total margin requirement for the first and second accounts that is less than the combined margin requirement. In some embodiments, the optimal reallocation is determined according to the optimization tool algorithm described above.

In some embodiments, the system 200 further includes third logic 210 stored in the memory 204 and executable by the processor 202 to cause the processor 202 to determine one or more modifications to the plurality of positions of the first account, the second account, or a combination thereof to achieve the determined optimal reallocation.

In some embodiments, the system 200 further includes fourth logic 212 stored in the memory 204 and executable by the processor 202 to cause the processor 202 to generate a set of proposed transactions to effect the determined one or more modifications.

In some embodiments, the first account may include an IR futures account and the second account may include an OTC IRS account but, in some embodiments, other types of accounts (including but not limited to securities accounts) may be included.

In some embodiments, the data may include data representative of an expression of risk for a margin account of the trader, composite delta statistics for every position which may be contained in the first account, OTC IRS data from an OTC IRS clearing system, base curves, foreign exchange rates, futures data and pricing for computation of risk offsets of Eurodollar and Treasury futures, a current allocation of futures within a PM account and futures/options contracts within a futures position SEG account, or the like, and combinations thereof.

In some embodiments, the first account comprises an IR futures account and, in some embodiments, the positions in the IR futures account comprise Eurodollar futures, Eurodollar options, Treasury futures, Treasury options, or the like, and combinations thereof.

In some embodiments, the second logic 208 is further executable by the processor 202 to cause the processor 202 to minimize volatility of the plurality of positions of each of the first and second accounts.

In some embodiments, the system 200 further includes fifth logic 214 stored in the memory 204 and executable by the processor 202 to cause the processor 202 to format the set of proposed transactions in a protocol which may be acted on by an exchange. In some embodiments, the protocol comprises FIX or FIXML.

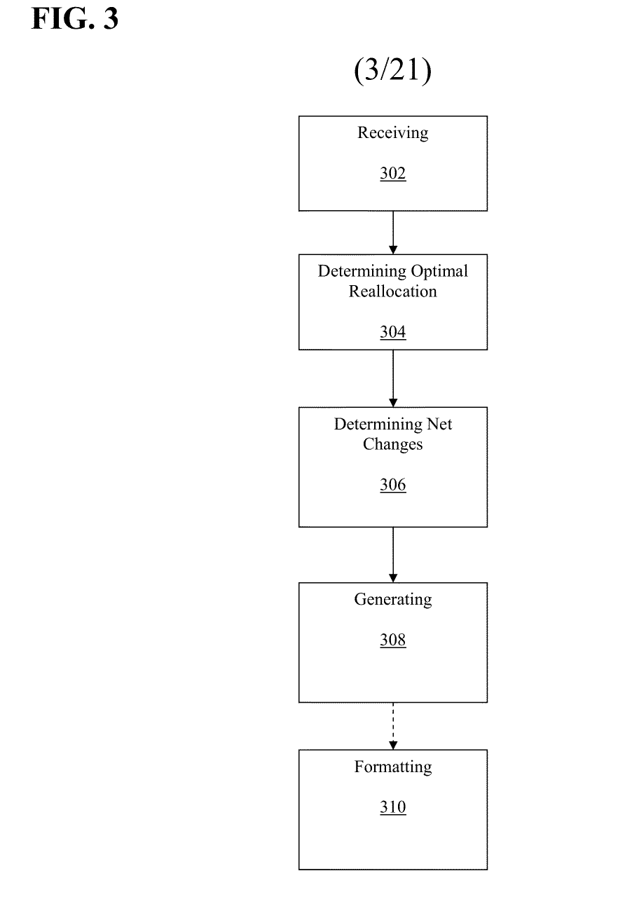

FIG. 3 depicts a flow chart showing exemplary operation of the system 200 of FIG. 2. In particular, FIG. 3 shows a computer-implemented method for minimizing a margin requirement of a trader holding first and second accounts (e.g., an IR futures account and an OTC IRS account), the first and second accounts being characterized by a combined margin requirement. In some embodiments, exemplary operation comprises: receiving, by a processor 202, data representative of a first plurality of positions in the first account and a second plurality of positions in the second account [Block 302]; determining, by the processor 202, an optimal reallocation of the first and second plurality of positions between the first and second accounts which results in a total margin requirement for the first and second accounts that is less than the combined margin requirement [Block 304]; determining, by the processor, one or more modifications to the plurality of positions of the first account, the second account, or a combination thereof to achieve the determined optimal reallocation [Block 306]; and generating a set of proposed transactions to effect the determined one or more modifications [Block 308].

In some embodiments, the first account comprises an IR futures account and the second account comprises an OTC IRS account.

In some embodiments, the data includes data representative of an expression of risk for a margin account of the trader, composite delta statistics for every position which may be contained in the first account, OTC IRS data from an OTC IRS clearing system, base curves, foreign exchange rates, futures data and pricing for computation of risk offsets of Eurodollar and Treasury futures, a current allocation of futures within a PM account and futures/options contracts within the futures position SEG account, or the like, and combinations thereof.

In some embodiments, the first account comprises an IR futures account and, in some embodiments, the positions in the IR futures account comprise Eurodollar futures, Eurodollar options, Treasury futures, Treasury options, or the like, and combinations thereof.

In some embodiments, the determination of optimal reallocation minimizes volatility of the plurality of positions of each of the first and second accounts.

In some embodiments, the operation of the system 200 further includes formatting, by the processor 202, the set of proposed transactions in a protocol that may be acted on by an exchange [Block 310]. In some embodiments, the protocol includes FIX or FIXML.

One skilled in the art will appreciate that one or more modules or logic described herein may be implemented using, among other things, a tangible computer-readable medium comprising computer-executable instructions (e.g., executable software code). Alternatively, in some embodiments, modules may be implemented as software code, firmware code, hardware, and/or a combination of the aforementioned. By way of example, in some embodiments, the modules may be embodied as part of an exchange 100 for financial instruments.

FIG. 4 shows a representative embodiment of a general computer system 400. In some embodiments, the computer system 400 includes a set of instructions that can be executed to cause the computer system 400 to perform any one or more of the methods or computer-based functions described herein. In some embodiments, the computer system 400 may operate as a standalone device or, in other embodiments, may be connected (e.g., using a network) to other computer systems and/or peripheral devices. Any of the components described above, including but not limited to the processor 202, may be a computer system 400 or a component in the computer system 400. In some embodiments, the computer system 400 may implement a match engine, margin processing, payment or clearing function on behalf of an exchange, such as the CME, of which embodiments in accordance with the present teachings are a component thereof.

In some embodiments, in a networked deployment, the computer system 400 may operate in the capacity of a server or as a client user computer in a client-server user network environment, or as a peer computer system in a peer-to-peer (or distributed) network environment. In some embodiments, the computer system 400 can also be implemented as or incorporated into various devices, including but not limited to a personal computer (PC), a tablet PC, a set-top box (STB), a PDA, a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, any other machine capable of executing a set of instructions (sequential or otherwise) that specify actions to be taken by that machine, or the like, and combinations thereof. In some embodiments, the computer system 400 can be implemented using electronic devices that provide voice, video or data communication. Further, it is to be understood that while a single computer system 400 is illustrated, the term “system” as used herein is meant to include any collection of systems or sub-systems that individually or jointly execute a set, or multiple sets, of instructions to perform one or more computer functions.

As shown in FIG. 4, the computer system 400 may include a processor 402, such as a central processing unit (CPU), a graphics processing unit (GPU), or both. In some embodiments, the processor 402 may be a component in a variety of systems. For example, the processor 402 may be part of a standard personal computer or a workstation. In some embodiments, the processor 402 may be one or more general processors, digital signal processors, application-specific integrated circuits, field programmable gate arrays, servers, networks, digital circuits, analog circuits, other now-known or later-developed devices for analyzing and processing data, or combinations thereof. In some embodiments, the processor 402 may implement a software program, such as code generated manually (i.e., programmed).

In some embodiments, the computer system 400 may include a memory 404 that can communicate via a bus 408. In some embodiments, the memory 404 may be a main memory, a static memory, or a dynamic memory. In some embodiments, the memory 404 may include but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media, or the like, and combinations thereof. In some embodiments, the memory 404 includes a cache or random access memory for the processor 402. In some embodiments, the memory 404 is separate from the processor 402, such as a cache memory of a processor, the system memory, or other memory. In some embodiments, the memory 404 may be an external storage device or database for storing data. Examples include but are not limited to a hard drive, compact disc (CD), digital video disc (DVD), memory card, memory stick, floppy disc, universal serial bus (USB) memory device, any other device operative to store data, or combinations thereof. In some embodiments, the memory 404 is operable to store instructions executable by the processor 402. In some embodiments, the functions, acts, or tasks illustrated in the figures and/or described herein may be performed by the programmed processor 402 executing the instructions 412 stored in the memory 404. In some embodiments, the functions, acts, or tasks are independent of the particular type of instructions set, storage media, processor, and/or processing strategy, and may be performed by software, hardware, integrated circuits, firm-ware, micro-code and the like, operating alone or in combination. Likewise, in some embodiments, processing strategies may include multiprocessing, multitasking, parallel processing, or the like, and combinations thereof.

As shown in FIG. 4, the computer system 400 may further include a display unit 414, such as a liquid crystal display (LCD), an organic light emitting diode (OLED), a flat panel display, a solid state display, a cathode ray tube (CRT), a projector, a printer, other now-known or later-developed display devices for outputting determined information, and combinations thereof. In some embodiments, the display 414 may act as an interface for the user to see the functioning of the processor 402 or, in some embodiments, as an interface with the software stored in the memory 404 or in the drive unit 406.

Additionally, in some embodiments, the computer system 400 may include an input device 416 configured to allow a user to interact with any of the components of system 400. In some embodiments, the input device 416 may be a number pad, a keyboard, or a cursor control device, such as a mouse, a joystick, a touch screen display, a remote control, any other device operative to interact with the system 400, or combinations thereof.

In some embodiments, as shown in FIG. 4, the computer system 400 may also include a disk or optical drive unit 406. In some embodiments, the disk drive unit 406 may include a computer-readable medium 410 in which one or more sets of instructions 412 (e.g., software) can be embedded. Further, in some embodiments, the instructions 412 may embody one or more of the methods or logic as described herein. In some embodiments, the instructions 412 may reside completely, or at least partially, within the memory 404 and/or within the processor 402 during execution by the computer system 400. In some embodiments, the memory 404 and the processor 402 also may include computer-readable media as described above.

In some embodiments in accordance with the present teachings, a computer-readable medium includes instructions 412 or receives and executes instructions 412 responsive to a propagated signal, so that a device connected to a network 420 can communicate voice, video, audio, images, and/or any other data over the network 420. In some embodiments, the instructions 412 may be transmitted or received over the network 420 via a communication interface 418. In some embodiments, the communication interface 418 may be a part of the processor 402 or may be a separate component. In some embodiments, the communication interface 418 may be created in software or may be a physical connection in hardware. In some embodiments, the communication interface 418 is configured to connect with a network 420, external media, the display 414, any other components in system 400, or combinations thereof. In some embodiments, the connection with the network 420 may be a physical connection, such as a wired Ethernet connection or may be established wirelessly as described below. Likewise, in some embodiments, the additional connections with other components of the system 400 may be physical connections or may be established wirelessly.

In some embodiments, the network 420 may include wired networks, wireless networks, or combinations thereof. In some embodiments, the wireless network may be a cellular telephone network, an 802.11, 802.16, 802.20, or WiMax network. In some embodiments, the network 420 may be a public network (e.g., the Internet), a private network (e.g., an intranet), or combinations thereof, and may utilize a variety of networking protocols now available or later developed including but not limited to TCP/IP-based networking protocols.

Embodiments in accordance with the present teachings and the functional operations described in this specification can be implemented in digital electronic circuitry, or in computer software, firmware, and/or hardware, including the structures described in this specification and their structural equivalents, or in combinations of one or more of them. Some embodiments of the subject matter described in this specification can be implemented as one or more computer program products (i.e., one or more modules of computer program instructions encoded on a computer-readable medium for execution by, or to control the operation of, a data processing apparatus). While in some embodiments the computer-readable medium is shown to be a single medium, the term “computer-readable medium” includes a single medium or multiple media, such as a centralized or distributed database, and/or associated caches and servers that store one or more sets of instructions. As used herein, the term “computer-readable medium” shall also include any medium that is capable of storing, encoding, or otherwise carrying a set of instructions for execution by a processor or that cause a computer system to perform any one or more of the methods or operations described herein. In some embodiments, the computer readable medium can be a machine-readable storage device, a machine-readable storage substrate, a memory device, or a combination of one or more of these. As used herein, the term “data processing apparatus” encompasses all apparatuses, devices, and machines for processing data, including but not limited to a programmable processor, a computer, multiple processors, multiple computers, or combinations thereof. In some embodiments, the apparatus can include, in addition to hardware, code that creates an execution environment for the computer program in question (e.g., code that constitutes processor firmware, a protocol stack, a database management system, an operating system, or a combination of one or more of these).

In some embodiments, the computer-readable medium can include a solid-state memory, such as a memory card or other package that houses one or more non-volatile read-only memories. In some embodiments, the computer-readable medium can be a random access memory or other volatile re-writable memory. Additionally, in some embodiments, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the present teachings are considered to include any one or more of a computer-readable medium or a distribution medium and other equivalents and successor media, in which data or instructions may be stored.

In some embodiments, dedicated hardware implementations, such as application-specific integrated circuits, programmable logic arrays, and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, systems in accordance with the present teachings encompass software, firmware, and hardware implementations.

In some embodiments, the methods described herein may be implemented by software programs executable by a computer system. Furthermore, in some embodiments, implementations can include distributed processing, component/object distributed processing, and parallel processing. In some embodiments, virtual computer system processing can be constructed to implement one or more of the methods or functionality as described herein.

Although the present specification describes components and functions that may be implemented in particular embodiments with reference to particular standards and protocols, the present teachings are not limited to such standards and protocols. By way of example, standards for Internet and other packet-switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those described herein are considered equivalents thereof.

A computer program (also known as a program, software, software application, script, and/or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. T he processes and logic flows can also be performed by, and apparatus can also be implemented as, special purpose logic circuitry, such as an FPGA (field programmable gate array) or an ASIC (application-specific integrated circuit).

Representative processors suitable for the execution of a computer program in accordance with the present teachings include but are not limited to both general and special purpose microprocessors, and any one or more processors of any kind of digital computer. Generally, a processor will receive instructions and data from a read-only memory a random access memory, or both. The minimal elements of a computer are a processor for performing instructions and one or more memory devices for storing instructions and data. In some embodiments, a computer will also include, or be operatively coupled to receive data from or transfer data to, or both, one or more mass storage devices for storing data (e.g., magnetic disks, magneto optical disks, or optical disks). However, a computer need not have such devices. Moreover, in some embodiments, a computer can be embedded in another device, such as a mobile telephone, a PDA, a mobile audio player, or a global positioning system (GPS) receiver, to name just a few. Computer readable media suitable for storing computer program instructions and data in accordance with the present teachings include all forms of non-volatile memory, media, and memory devices, including but not limited to semiconductor memory devices (e.g., EPROM, EEPROM, flash memory devices, etc.), magnetic disks (e.g., internal hard disks or removable disks, magneto optical disks, etc.), and CD ROM and DVD-ROM disks. In some embodiments, the processor and/or the memory can be supplemented by, or incorporated in, special purpose logic circuitry.

To provide for interaction with a user, some embodiments can be implemented on a device having a display, such as a CRT or LCD monitor, for displaying information to the user, and a keyboard and a pointing device (e.g., a mouse or a trackball) by which the user can provide input to the computer. Other kinds of devices can be used to provide for interaction with a user as well. By way of example, feedback provided to the user can be any form of sensory feedback (e.g., visual feedback, auditory feedback, or tactile feedback), and input from the user can be received in any form (including but not limited to acoustic, speech, and/or tactile input.

Some embodiments in accordance with the present teachings can be implemented in a computing system that includes a back-end component (e.g., as a data server) or that includes a middleware component (e.g., an application server) or that includes a front-end component (e.g., a client computer having a graphical user interface or a Web browser through which a user can interact with an implementation of the subject matter described herein), or any combination of one or more such back-end, middleware, or front-end components. In some embodiments, the components of the system can be interconnected by any form or medium of digital data communication (e.g., a communication network). Examples of communication networks include but are not limited to LANs and WANs (e.g., the Internet).

In some embodiments, the computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding claim—whether independent or dependent—and that such new combinations are to be understood as forming a part of the present specification.

It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method for minimizing a margin requirement of a trader holding first and second accounts, the first and second accounts being characterized by a combined margin requirement, the method comprising:
receiving, by a processor, data representative of a first plurality of positions in the first account and a second plurality of positions in the second account;
determining, by the processor, an optimal reallocation of the first and second plurality of positions between the first and second accounts which results in a total margin requirement for the first and second accounts that is less than the combined margin requirement;
determining, by the processor, one or more modifications to the plurality of positions of the first account, the second account, or a combination thereof to achieve the determined optimal reallocation; and
generating a set of proposed transactions to effect the determined one or more modifications.

2. The computer-implemented method of claim 1 wherein the first account comprises an interest rate futures account, and wherein the second account comprises an over-the-counter interest rate swap account.

3. The computer-implemented method of claim 1 wherein the data comprises information selected from the group consisting of an expression of risk for a margin account of the trader, composite delta statistics for every position which may be contained in the first account, over-the-counter interest rate swap data from an over-the-counter interest rate swap clearing system, base curves, foreign exchange rates, futures data and pricing for computation of risk offsets of Eurodollar and Treasury futures, a current allocation of futures within a Portfolio Margin (PM) account and futures/options contracts within a segregated futures position account, and combinations thereof.

4. The computer-implemented method of claim 3 wherein the first account comprises an interest rate futures account, the positions therein comprising Eurodollar futures, Eurodollar options, Treasury futures, Treasury options, or combinations thereof.

5. The computer-implemented method of claim 1 wherein the determination of optimal reallocation minimizes volatility of the plurality of positions of each of the first and second accounts.

6. The computer-implemented method of claim 1 further comprising formatting, by the processor, the set of proposed transactions in a protocol which may be acted on by an Exchange.

7. The computer-implemented method of claim 6 wherein the protocol comprises FIX.

8. A system for minimizing a margin requirement of a trader holding first and second accounts, the first and second accounts being characterized by a combined margin requirement, the system comprising:
first logic stored in a memory and executable by a processor to cause the processor to receive data representative of a first plurality of positions in the first account and a second plurality of positions in the second account;
second logic stored in the memory and executable by the processor to cause the processor to determine an optimal reallocation of the first and second plurality of positions between the first and second accounts which results in a total margin requirement for the first and second accounts that is less than the combined margin requirement;
third logic stored in the memory and executable by the processor to cause the processor to determine one or more modifications to the plurality of positions of the first account, the second account, or a combination thereof to achieve the determined optimal reallocation; and
fourth logic stored in the memory and executable by the processor to cause the processor to generate a set of proposed transactions to effect the determined one or more modifications.

9. The system of claim 8 wherein the first account comprises an interest rate futures account, and wherein the second account comprises an over-the-counter interest rate swap account.

10. The system of claim 8 wherein the data comprises information selected from the group consisting of an expression of risk for a margin account of the trader, composite delta statistics for every position which may be contained in the first account, over-the-counter interest rate swap data from an over-the-counter interest rate swap clearing system, base curves, foreign exchange rates, futures data and pricing for computation of risk offsets of Eurodollar and Treasury futures, a current allocation of futures within a Portfolio Margin (PM) account and futures/options contracts within a segregated futures position account, and combinations thereof.

11. The system of claim 10 wherein the first account comprises an interest rate futures account, the positions therein comprising Eurodollar futures, Eurodollar options, Treasury futures, Treasury options, or combinations thereof.

12. The system of claim 8 wherein the second logic is further executable by the processor to cause the processor to minimize volatility of the plurality of positions of each of the first and second accounts.

13. The system of claim 8 further comprising fifth logic stored in the memory and executable by the processor to cause the processor to format the set of proposed transactions in a protocol which may be acted on by an Exchange.

14. The system of claim 13 wherein the protocol comprises FIX.

15. A system for minimizing a margin requirement of a trader holding first and second accounts, the first and second accounts being characterized by a combined margin requirement, the system comprising:
means for receiving data representative of a first plurality of positions in the first account and a second plurality of positions in the second account;
means for determining an optimal reallocation of the first and second plurality of positions between the first and second accounts, which results in a total margin requirement for the first and second accounts that is less than the combined margin requirement;
means for determining one or more modifications to the plurality of positions of the first account, the second account, or a combination thereof to achieve the determined optimal reallocation; and
means for generating a set of proposed transactions to effect the determined one or more modifications.

16. The system of claim 15 wherein the first account comprises an interest rate futures account, and wherein the second account comprises an over-the-counter interest rate swap account.

17. The system of claim 15 wherein the data comprises information selected from the group consisting of an expression of risk for a margin account of the trader, composite delta statistics for every position which may be contained in the first account, over-the-counter interest rate swap data from an over-the-counter interest rate swap clearing system, base curves, foreign exchange rates, futures data and pricing for computation of risk offsets of Eurodollar and Treasury futures, a current allocation of futures within a Portfolio Margin (PM) account and futures/options contracts within a segregated futures position account, and combinations thereof.

18. The system of claim 15 wherein the first account comprises an interest rate futures account, the positions therein comprising Eurodollar futures, Eurodollar options, Treasury futures, Treasury options, or combinations thereof.

19. The system of claim 15 wherein the means for determining the optimal reallocation comprises means for minimizing volatility of the plurality of positions of each of the first and second accounts.

20. The system of claim 15 further comprising means for formatting the set of proposed transactions in a protocol which may be acted on by an Exchange.

21. The system of claim 20 wherein the protocol comprises FIX.
